(19) United States
(12) Patent Application Publication
(10) Pub. No.: US 2026/0310627 A1
(43) Pub. Date: Oct. 8, 2026

(54) SYSTEMS AND METHODS FOR ISOLATED INTERFACES WITH INTEGRATED ENERGY MEASUREMENT AND CALIBRATION

(71) Applicant: Nunami Inc., San Jose, CA (US)

(72) Inventor: Syed Enam Rehman, Milpitas, CA (US)

(21) Appl. No.: 19/630,084

(22) Filed: Mar. 26, 2026

Related U.S. Application Data
(60) Provisional application No. 63/778,334, filed on Mar. 26, 2025.

(51) Int. Cl. G06F 13/42

(52) U.S. Cl. CPC G06F 13/4282; G06F 2213/0002

(57) ABSTRACT

An interface system includes an edge domain comprising an edge processing unit configured to execute diagnostic and networking functions, a first fault handling subsystem configured to detect and respond to abnormal conditions, and a first isolated transceiver. The system includes a process domain comprising a process interface configured to connect to at least one of sensors, actuators, and power electronics, a second fault handling subsystem configured to detect and respond to abnormal conditions, and a second isolated transceiver. A galvanically isolated barrier is disposed between the edge domain and the process domain, providing galvanic isolation between them. The first and second isolated transceivers are configured to communicate via packet-based serial communication across the galvanically isolated barrier, and the edge domain and process domain are independently powered.

### CROSS-REFERENCE TO RELATED APPLICATIONS

This application claims the benefit of U.S. Provisional Patent Application No. 63/778,334, filed Mar. 26, 2026, the entire contents of which are incorporated herein by reference.

### FIELD OF INVENTION

The present disclosure relates to interface systems for industrial, automotive, and energy infrastructure applications, and more particularly to an edge safety interface architecture that integrates galvanically isolated communication, fault handling, energy measurement, and continuous in-system auto-calibration across independently powered domains.

### BACKGROUND

Galvanic isolation is a technique used in electronic systems to prevent direct electrical conduction between two or more circuits while still permitting signal or power transfer between them. This technique finds widespread application in various electronic systems, including but not limited to automotive, industrial, energy infrastructure, medical, telecommunications, aerospace, and consumer electronics systems, where safety considerations require separation between high-voltage domains and low-voltage control or processing circuits. Galvanic isolation protects sensitive electronics from high-voltage transients, prevents ground loops, and ensures operator safety in systems that interface with hazardous voltage levels.

Conventional approaches to galvanic isolation have employed various technologies, including optocouplers and digital isolators. Optocouplers use light-emitting diodes and photodetectors to transfer signals across an isolation barrier, while digital isolators transmit high-frequency RF signals between transceivers separated by a dielectric insulator. Digital isolators have gained popularity due to their ability to provide higher data rates, wider temperature range operation, and reduced susceptibility to age-based degradation compared to optocouplers.

Some digital isolator implementations integrate the transceivers and insulator within a single package, which can result in limited distance through insulation and constrained internal clearance distances between isolated interfaces. These package-level constraints may affect the intrinsic reliability of the isolation under electrical overstress conditions. Additionally, when the insulator and transceiver are integrated on the same substrate, the isolator may be vulnerable to damage from electrical overstress events in the field.

In systems requiring both isolation and measurement capabilities, such as energy metering applications, additional challenges arise. Analog front-end circuits used for sensing voltage and current are subject to drift over time due to aging effects, temperature variation, and component tolerances. Maintaining measurement accuracy over the lifetime of a deployed system can be difficult, particularly when the system operates in environments with varying conditions. Conventional calibration approaches may require external references or calibration cycles that interrupt normal operation, making in-field recalibration impractical for many deployed systems.

Furthermore, applications involving multiple isolated subsystems often require coordinated timing for operations such as data acquisition, waveform capture, or distributed control events. Achieving synchronization across galvanically isolated domains presents challenges, as conventional approaches may rely on centralized clock distribution or non-isolated trigger lines, which can compromise safety isolation or introduce timing uncertainties from external wiring or clock drift.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an interface system is provided. The interface system includes an edge domain including an edge processing unit configured to execute diagnostic and networking functions, a first fault handling subsystem configured to detect and respond to abnormal conditions, and a first isolated transceiver. The interface system includes a process domain including a process interface configured to connect to at least one of sensors, actuators, and power electronics, a second fault handling subsystem configured to detect and respond to abnormal conditions, and a second isolated transceiver. The interface system includes a galvanically isolated barrier disposed between the edge domain and the process domain, the galvanically isolated barrier providing galvanic isolation between the edge domain and the process domain. The first isolated transceiver and the second isolated transceiver are configured to communicate via packet-based serial communication across the galvanically isolated barrier, and the edge domain and the process domain are independently powered.

According to other aspects of the present disclosure, the interface system may include one or more of the following features. The first isolated transceiver may include a first serializer-deserializer configured to serialize outgoing data packets and deserialize incoming data packets, and the second isolated transceiver may include a second serializer-deserializer configured to serialize outgoing data packets and deserialize incoming data packets, and the first isolated transceiver and the second isolated transceiver may be configured to communicate via full-duplex communication. The first isolated transceiver and the second isolated transceiver may be configured to use Manchester encoding and at least one of On-Off Keying modulation and Amplitude Shift Keying modulation. The galvanically isolated barrier may include embedded ground shields configured to suppress electromagnetic interference. The galvanically isolated barrier may include capacitive coupling structures formed in a multilayer printed circuit board. The galvanically isolated barrier may include inductive coupling structures. The edge processing unit may be configured to run a real-time operating system and implement at least one of diagnostic functions, analytics functions, and networking functions. The edge processing unit may be configured to support at least one of Ethernet protocols and IP protocols. The first fault handling subsystem may be configured to detect at least one of abnormal electrical conditions and abnormal thermal conditions. The first fault handling subsystem may be configured to initiate containment actions without relying on a system processor. The interface system may further include a synchronization mechanism configured to coordinate operation across the edge domain and the process domain by encoding a trigger signal within a serial communication protocol. The first isolated transceiver may be configured to operate as a master and generate the trigger signal, and the first isolated transceiver may be configured to encode the trigger signal in at least one of a packet preamble and a packet header. The second isolated transceiver may be configured to operate as a slave and detect the trigger signal from an incoming data packet and assert a local trigger input signal to initiate a time-aligned operation. The synchronization mechanism may be scalable to coordinate operation across a plurality of slave subsystems, each slave subsystem independently decoding the trigger signal from a packet preamble. The synchronization mechanism may provide deterministic latency between generation of the trigger signal and detection of the trigger signal, the deterministic latency governed by serialization delay and transmission delay of the serial communication protocol. The first isolated transceiver and the second isolated transceiver may be configured to support full-duplex communication while honoring synchronized triggers.

According to another aspect of the present disclosure, an interface system is provided. The interface system includes an edge domain including an edge processing unit, a first fault handling subsystem, and a master transceiver module. The master transceiver module includes a media access controller, a packet generator configured to assemble request packets with command codes and data, and a transmit path including a header addition block, a serializer configured to perform serialization, and a checksum addition block. The interface system includes a process domain including a process interface, a second fault handling subsystem, and a slave transceiver module. The slave transceiver module includes a receive path including a header detection block, a deserializer configured to perform deserialization, and a checksum comparison block. The interface system includes a galvanically isolated barrier disposed between the edge domain and the process domain. The master transceiver module and the slave transceiver module are configured to communicate via full-duplex, packet-based serial communication across the galvanically isolated barrier.

According to other aspects of the present disclosure, the interface system may include one or more of the following features. The master transceiver module may further include a receive path including a header detection block, a deserializer, and a checksum comparison block, and the slave transceiver module may further include a transmit path including a header addition block, a serializer, and a checksum addition block. The master transceiver module may be configured to handle link integrity monitoring, interrupt generation, and slave-side status indicators.

According to another aspect of the present disclosure, an interface system is provided. The interface system includes a master subsystem including a master transceiver with an internal trigger logic block configured to generate a trigger pulse and a transmit block configured to encode the trigger pulse into a preamble or header of an outgoing data packet. The interface system includes a plurality of slave subsystems, each slave subsystem including a slave transceiver with a receive block configured to detect the trigger pulse from an incoming data packet and assert a local trigger input signal. The interface system includes a galvanically isolated barrier disposed between the master subsystem and each of the plurality of slave subsystems. The master subsystem and the plurality of slave subsystems are configured to achieve deterministic synchronization across the galvanically isolated barrier without a shared physical clock.

According to another aspect of the present disclosure, an energy meter system is provided. The energy meter system includes a host-side domain including a host processor and a first isolated transceiver. The energy meter system includes a process-side measurement domain including a second isolated transceiver, an analog front-end including a plurality of programmable gain amplifiers and a plurality of analog-to-digital converters, an energy measurement digital signal processor, and a monitoring supervisor. The energy meter system includes a galvanic isolation channel disposed between the host-side domain and the process-side measurement domain. The first isolated transceiver and the second isolated transceiver are configured to communicate via serial communication across the galvanic isolation channel, and the process-side measurement domain is configured to be powered independently from the host-side domain.

According to other aspects of the present disclosure, the energy meter system may include one or more of the following features. The energy measurement digital signal processor may be configured to compute at least one of RMS voltage, RMS current, real power, reactive power, and power factor. The energy measurement digital signal processor may be configured to compute at least one of harmonic content and transient events. The energy measurement digital signal processor may be configured to be powered from a measured power line. The monitoring supervisor may be configured to detect anomalies by comparing computed parameters against programmable threshold limits. The monitoring supervisor may be configured to autonomously trigger a fault response upon detecting a deviation from the programmable threshold limits, the fault response including at least one of system shutdown and relay trip. The monitoring supervisor may incorporate machine learning configured to detect abnormal patterns indicative of at least one of a fault and a threat. The abnormal patterns may be programmable through the galvanic isolation channel for various application conditions. The first isolated transceiver and the second isolated transceiver may be configured to communicate via a high-speed serial interface. The first isolated transceiver and the second isolated transceiver may be configured to use Manchester encoding and clock recovery. The galvanic isolation channel may include at least one of capacitive coupling and inductive coupling with ground shielding structures. The host-side domain may be configured to integrate with a master controller via at least one of UART and I2C protocols. The host-side domain may be configured to provide programmable threshold settings via a host interface. The energy meter system may further include isolated general-purpose input/output interfaces for local control. The analog front-end may include differential inputs for voltage sensing and current sensing. The plurality of analog-to-digital converters may include high-resolution analog-to-digital converters.

According to another aspect of the present disclosure, an energy meter system is provided. The energy meter system includes a host-side domain including a host microcontroller unit, a fault handler, and a first isolated interface. The energy meter system includes a process-side domain including a second isolated interface, a process microcontroller unit, a fault handler, an energy measurement digital signal processor, a plurality of programmable gain amplifiers connected to differential voltage inputs and differential current inputs, a plurality of analog-to-digital converters connected to the plurality of programmable gain amplifiers, and a monitoring supervisor configured to detect anomalies and trigger fault responses. The energy meter system includes a galvanic isolation channel disposed between the host-side domain and the process-side domain, the galvanic isolation channel including at least one of capacitive coupling structures and inductive coupling structures.

According to other aspects of the present disclosure, the energy meter system may include one or more of the following features. The host-side domain may further include at least one of a bias circuit, a temperature sense block, and a clock generation circuit. The process-side domain may further include at least one of a bias circuit, a temperature sense block, a voltage reference, and a clock generation circuit.

According to another aspect of the present disclosure, an energy meter system is provided. The energy meter system includes a process-side measurement domain including an analog front-end, an energy measurement digital signal processor, and a monitoring supervisor. The monitoring supervisor is configured to oversee computed parameters and identify anomalies or violations of programmable threshold limits. The monitoring supervisor is configured to autonomously trigger a fault response upon detecting a deviation indicative of at least one of sustained overcurrent, voltage imbalance, and harmonic distortion. The monitoring supervisor incorporates machine learning configured to detect abnormal patterns, the abnormal patterns being programmable for various application conditions.

According to another aspect of the present disclosure, an energy meter system is provided. The energy meter system includes a process-side measurement domain including an analog front-end with a voltage sensing path and a current sensing path, an energy measurement digital signal processor, a voltage digital-to-analog converter configured to inject a first calibration signal into the voltage sensing path, and a current digital-to-analog converter configured to inject a second calibration signal into the current sensing path. The first calibration signal and the second calibration signal include pseudo-random calibration signals occupying a frequency band higher than a fundamental power frequency and harmonics thereof. The energy measurement digital signal processor is configured to isolate the first calibration signal and the second calibration signal from measurement signals and dynamically adjust compensation to correct sensor drift.

According to other aspects of the present disclosure, the energy meter system may include one or more of the following features. The first calibration signal and the second calibration signal may be injected in parallel with actual measurement signals from a power line. The frequency band of the first calibration signal and the second calibration signal may be separated from the fundamental power frequency to ensure no interference with energy measurement. The energy measurement digital signal processor may be configured to employ digital filtering and spectral separation techniques to isolate the pseudo-random calibration signals from the measurement signals. The energy measurement digital signal processor may be configured to compute gain deviations and offset deviations introduced by the voltage sensing path and the current sensing path. The energy measurement digital signal processor may be configured to compare received calibration signals with expected signatures to compute the gain deviations and the offset deviations. The energy measurement digital signal processor may be configured to continuously correct sensor drift. The auto-calibration may avoid external references or calibration cycles that interrupt normal operation. The auto-calibration may enable in-field recalibration. The energy meter system may further include a filter and mixer block configured to demodulate the first calibration signal and the second calibration signal and calculate correction factors. The filter and mixer block may include filters configured to suppress energy frequency content and isolate the pseudo-random calibration signals. Error metrics from the filter and mixer block may be used to compensate measurement parameters dynamically. The first calibration signal and the second calibration signal may traverse a same sensing path as actual measurements. A full signal chain may be exercised during calibration. The auto-calibration may be configured to correct for aging effects. The auto-calibration may be configured to correct for at least one of temperature variation and component tolerances.

According to another aspect of the present disclosure, an energy meter system is provided. The energy meter system includes a host-side domain including a host microcontroller unit and a first isolated interface. The energy meter system includes a process-side domain including a second isolated interface, an energy measurement and auto-calibration digital signal processor, a plurality of programmable gain amplifiers connected to differential voltage inputs and differential current inputs, a plurality of analog-to-digital converters connected to the plurality of programmable gain amplifiers, a voltage digital-to-analog converter configured to output a voltage calibration signal to a voltage calibration output, and a current digital-to-analog converter configured to output a current calibration signal to a current calibration output. The energy meter system includes a galvanic isolation channel disposed between the host-side domain and the process-side domain. The voltage calibration signal and the current calibration signal include pseudo-random signals at a frequency band higher than a fundamental power frequency.

According to other aspects of the present disclosure, the energy meter system may include one or more of the following features. The energy measurement and auto-calibration digital signal processor may include an auto-calibration module configured to extract and quantify at least one of distortion and gain error from a composite signal. The voltage digital-to-analog converter and the current digital-to-analog converter may be controlled by at least one of the host microcontroller unit and the energy measurement and auto-calibration digital signal processor.

According to another aspect of the present disclosure, a method for calibration of an energy meter is provided. The method includes injecting, by a voltage digital-to-analog converter, a first pseudo-random calibration signal into a voltage sensing path, the first pseudo-random calibration signal occupying a frequency band higher than a fundamental power frequency. The method includes injecting, by a current digital-to-analog converter, a second pseudo-random calibration signal into a current sensing path, the second pseudo-random calibration signal occupying the frequency band higher than the fundamental power frequency. The method includes digitizing, by a plurality of analog-to-digital converters, composite signals including actual measurement signals and the first and second pseudo-random calibration signals. The method includes isolating, by a digital signal processor, the first and second pseudo-random calibration signals from the actual measurement signals using digital filtering and spectral separation. The method includes computing, by the digital signal processor, gain deviations and offset deviations by comparing received calibration signals with expected signatures. The method includes dynamically adjusting, by the digital signal processor, compensation algorithms to correct sensor drift based on the computed gain deviations and offset deviations.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of an Edge Safety Interface architecture with galvanically isolated domains, according to aspects of the present disclosure.

FIG. 2 illustrates a block diagram of a transceiver system configured for full-duplex serial communication across a galvanically isolated interface, according to aspects of the present disclosure.

FIG. 3 illustrates a block diagram of a master module configured for packet-based serial communication across a galvanically isolated interface, according to aspects of the present disclosure.

FIG. 4 illustrates a block diagram of a slave module configured to operate within an isolated interface system, according to aspects of the present disclosure.

FIG. 5 illustrates a synchronization mechanism for multiple isolated interfaces within an Edge Safety Interface architecture, according to aspects of the present disclosure.

FIG. 6 illustrates a block diagram of an isolated energy meter system implemented using the Edge Safety Interface architecture, according to aspects of the present disclosure.

FIG. 7 illustrates a circuit diagram of an isolated energy meter in a single-phase power measurement configuration, according to aspects of the present disclosure.

FIG. 8 illustrates a block diagram of an isolated energy meter system with auto-calibration capabilities, according to aspects of the present disclosure.

FIG. 9 illustrates a system diagram of an auto-calibration mechanism for an isolated energy meter, according to aspects of the present disclosure.

FIG. 11 illustrates a flowchart of a method for calibration of an energy meter, according to aspects of the present disclosure.

FIG. 10 illustrates an application schematic of an isolated energy meter with auto-calibration functionality, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Conventional isolated communication interfaces for industrial, automotive, and energy infrastructure applications present numerous technical challenges. Standard integrated isolators typically exhibit limited dielectric strength and short internal clearances, which constrain the voltage isolation capabilities and reduce reliability in high-voltage environments. These limitations become particularly problematic in applications where robust galvanic isolation between high-voltage process environments and sensitive edge computing systems is required.

System complexity increases substantially when designers rely on multiple discrete components to achieve adequate isolation performance. Traditional isolation techniques often necessitate separate subsystems for diagnostics and safety monitoring because integrated isolators lack built-in fault handling capabilities. This separation increases development overhead, complicates system design, and introduces additional failure modes associated with interconnections between discrete components.

Energy metering solutions requiring galvanic isolation face additional challenges related to measurement accuracy over time. Aging effects, temperature variation, and component tolerances in analog front-end circuitry cause measurement drift that degrades precision. Traditional calibration methods address this drift by requiring external references or calibration cycles that interrupt normal operation, making in-field recalibration impractical for deployed systems. This limitation is particularly problematic in applications demanding continuous, high-accuracy power quality monitoring.

Synchronization across multiple isolated measurement or control subsystems presents further difficulties. Conventional approaches require centralized clock distribution or non-isolated trigger lines to coordinate timing across distributed subsystems. Centralized clock distribution compromises safety isolation by introducing electrical connections between domains that should remain galvanically separated. Non-isolated trigger lines introduce jitter or skew from external wiring or clock drift, reducing timing precision in applications requiring nanosecond-to-microsecond accuracy.

The present disclosure describes an Edge Safety Interface (ESI) architecture that addresses these technical challenges through a unified approach combining edge computing, safety isolation, high-speed communication, and precision energy measurement with continuous in-system calibration capabilities. The ESI architecture partitions functionality into two distinct domains separated by a galvanically isolated barrier: an edge domain responsible for computation and diagnostics, and a process domain responsible for direct interaction with the physical environment through sensors, actuators, and power electronics. The edge domain and the process domain are independently powered, ensuring that each domain may maintain operation during failure conditions in the other domain.

Communication between the edge domain and the process domain is achieved using high-speed serial links transmitted over external isolated channels, such as capacitive or inductive coupling structures embedded in a printed circuit board. This approach enables both safety and performance without relying on traditional on-chip or co-packaged isolation. The isolation structures may be surrounded by embedded ground shields that suppress electromagnetic interference, reduce emissions, and protect the isolation layer from environmental degradation.

A transceiver system described herein enables full-duplex, packet-based serial communication across the galvanically isolated barrier. The transceiver system includes a master module on the edge domain and a slave module on the process domain. The master module and the slave module communicate asynchronously over high-speed serial links using serializer-deserializer functionality and radio frequency transceiver designs. The transceiver system may use Manchester encoding and modulation techniques such as On-Off Keying or Amplitude Shift Keying to transmit data across the isolation barrier.

A synchronization mechanism described herein coordinates operation across multiple isolated ESI subsystems by embedding trigger signals within the serial communication protocol. A master subsystem generates a trigger pulse and encodes the trigger pulse into a preamble or header of an outgoing data packet. Each slave subsystem detects the trigger pulse from an incoming data packet and asserts a local trigger input signal to initiate a time-aligned operation. This approach achieves deterministic synchronization across galvanically isolated domains without requiring a shared physical clock or centralized clock distribution.

An isolated energy meter implementation described herein includes precision analog front-end circuitry for sensing voltage and current, a dedicated energy measurement digital signal processor, and a monitoring supervisor module for autonomous fault detection and response. The energy measurement digital signal processor may compute power and energy metrics including RMS voltage, RMS current, real power, reactive power, power factor, harmonic content, and transient events. The monitoring supervisor may incorporate machine learning to detect abnormal patterns indicative of a fault or a threat.

An automatic calibration mechanism described herein enables continuous, in-system correction of drift and error in voltage and current sensing elements. The automatic calibration mechanism injects known pseudo-random calibration signals into the voltage and current sensing paths using dedicated digital-to-analog converters. The calibration signals occupy a frequency band higher than the fundamental power frequency and harmonics thereof, ensuring that the injected calibration signals do not interfere with the energy signals being measured. The energy measurement digital signal processor isolates the known pseudo-random signals from the measurement signals and computes gain and offset deviations, which are then used to dynamically adjust compensation algorithms.

The architectures and methods described herein provide reduced system complexity by combining edge computing, safety isolation, and interface functionality into cohesive modules. Enhanced safety compliance results from employing discrete external isolation components with enhanced distance-through-insulation and clearance distances. Robust electromagnetic immunity is achieved through embedded ground shielding structures. Deterministic fault response is enabled through independent fault handling subsystems in each domain. High measurement accuracy over device lifetime is maintained through continuous in-system calibration. Support for in-field recalibration is provided without requiring external references or calibration cycles that interrupt normal operation.

The architectures and methods described herein may be implemented in data center power distribution and monitoring systems, where the isolated energy meter with auto-calibration capabilities enables continuous, high-accuracy power quality monitoring across multiple server racks and power distribution units. The ESI architecture allows data center operators to maintain real-time visibility into power consumption, detect anomalies, and implement predictive maintenance strategies while ensuring robust galvanic isolation between high-voltage power infrastructure and sensitive information technology networking equipment.

The architectures and methods described herein may be implemented in electric vehicle charging infrastructure, where the ESI architecture provides galvanic isolation between charging power electronics and edge computing systems that manage billing, authentication, and grid communication. The integrated fault handling and monitoring supervisor capabilities enable autonomous detection and response to overcurrent conditions, voltage imbalances, or other electrical hazards.

The architectures and methods described herein may be implemented in battery management systems for energy storage applications, where the synchronization mechanism enables coordinated monitoring and control across multiple battery modules while maintaining galvanic isolation between each module and a central management controller. The ability to embed trigger signals within the serial communication protocol allows for deterministic, time-aligned data acquisition across distributed battery cells.

The architectures and methods described herein may be implemented in industrial automation networks, where the transceiver system enables reliable, high-speed communication between programmable logic controllers and field devices such as sensors, actuators, and motor drives operating in electrically harsh environments. The enhanced distance-through-insulation and embedded ground shielding provide robust protection against electromagnetic interference and high-voltage transients.

The architectures and methods described herein may be implemented in three-phase power analysis and protective relaying applications, where the synchronization mechanism enables nanosecond-to-microsecond precision timing across multiple measurement channels for accurate phase angle measurements, harmonic analysis, and coordinated fault detection and isolation.

The galvanically isolated barrier disposed between the edge domain and the process domain may be implemented using various coupling structures that enable signal transmission while maintaining electrical separation between the two domains. As described previously, the galvanically isolated barrier provides galvanic isolation between the edge domain and the process domain, enabling high-speed serial communication without direct electrical connection.

The galvanically isolated barrier may include capacitive coupling structures formed in a multilayer printed circuit board. The capacitive coupling structures may be formed using overlapping plates within the multilayer printed circuit board. The overlapping plates may be positioned on different layers of the multilayer printed circuit board, with dielectric material of the printed circuit board providing the insulating medium between the plates. The overlapping plate configuration creates a capacitive element that allows alternating current signals to pass between the edge domain and the process domain while blocking direct current paths. The geometry of the overlapping plates, including plate area and separation distance, may be selected to achieve desired coupling characteristics for the high-speed serial communication.

The galvanically isolated barrier may include inductive coupling structures as an alternative or supplement to capacitive coupling structures. The inductive coupling structures may be formed using overlapping loops within the multilayer printed circuit board. The overlapping loops may be implemented as planar spiral inductors or other loop configurations positioned on different layers of the multilayer printed circuit board. Magnetic coupling between the overlapping loops enables signal transmission across the isolation barrier. The inductive coupling structures provide an alternative signal path that may offer different frequency response characteristics compared to capacitive coupling structures.

The galvanically isolated barrier may include embedded ground shields configured to suppress electromagnetic interference. The embedded ground shields may surround the capacitive coupling structures or the inductive coupling structures within the multilayer printed circuit board. The embedded ground shields may be implemented as conductive planes or traces positioned on layers adjacent to the coupling structures. The embedded ground shields reduce emissions from the coupling structures and attenuate external electromagnetic interference that could otherwise couple into the signal paths. The embedded ground shields also protect the isolation layer from environmental degradation by providing a barrier against moisture ingress and contamination that could reduce the dielectric strength of the isolation barrier over time. This protection increases long-term reliability of the galvanically isolated barrier.

The isolation structures may maintain compliance with safety standards such as UL1577 and IEC 60747. Compliance with these safety standards may be achieved through selection of appropriate distance-through-insulation and clearance distances for the coupling structures. The distance-through-insulation refers to the shortest path through insulating material between conductive elements on opposite sides of the isolation barrier. The clearance distance refers to the shortest path through air or along surfaces between conductive elements. The multilayer printed circuit board construction allows designers to specify layer stackup configurations that achieve the distance-through-insulation and clearance distances required by the applicable safety standards. The dielectric materials used in the multilayer printed circuit board may be selected based on their dielectric strength, tracking resistance, and long-term stability to support compliance with the safety standards.

In an example,, the galvanically isolated barrier referred to herein may be similar to, or the same as, the galvanically isolated barrier as described in U.S. Pat. No. 11,706,057, issued Jul. 18, 2023, titled “DEVICES, SYSTEMS, AND METHODS FOR SERIAL COMMUNICATION OVER A GALVANICALLY ISOLATED CHANNEL,” which is incorporated by reference herein.

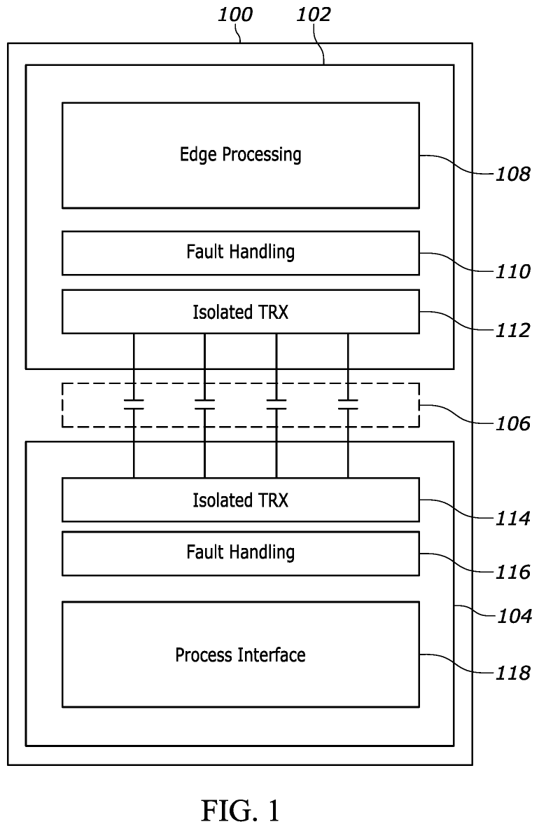

Referring to FIG. 1, an Edge Safety Interface (ESI) architecture 100 is illustrated. The ESI architecture 100 partitions functionality into two distinct domains separated by a galvanically isolated barrier 106: an edge domain 102 and a process domain 104. The edge domain 102 includes an edge processing block 108, a first fault handling subsystem 110, and a first isolated transceiver 112. The process domain 104 includes a second isolated transceiver 114, a second fault handling subsystem 116, and a process interface block 118. The galvanically isolated barrier 106 is disposed between the edge domain 102 and the process domain 104, providing galvanic isolation between the two domains while enabling communication through the first isolated transceiver 112 and the second isolated transceiver 114.

The edge processing block 108 within the edge domain 102 is configured to execute real-time operating systems and implement diagnostic, analytics, and networking functions. The edge processing block 108 may support protocols such as Ethernet and IP and may provide secure APIs for external systems. The edge processing block 108 is configured to remain operational even when power is lost on the process domain 104 side, ensuring availability of fault logs, telemetry, and diagnostics for predictive maintenance.

Adjacent to the edge processing block 108, the first fault handling subsystem 110 independently detects and responds to abnormal electrical or thermal conditions within the edge domain 102. The first fault handling subsystem 110 initiates local containment actions and alerts the edge processing block 108 without relying on a system processor. The second fault handling subsystem 116 within the process domain 104 operates independently from the first fault handling subsystem 110 to detect and respond to abnormal conditions within the process domain 104. The independent operation of the first fault handling subsystem 110 and the second fault handling subsystem 116 enables each domain to maintain fault detection and response capabilities regardless of the operational status of the other domain.

The first isolated transceiver 112 and the second isolated transceiver 114 are positioned on opposite sides of the galvanically isolated barrier 106 and facilitate communication across the galvanically isolated barrier 106. The first isolated transceiver 112 and the second isolated transceiver 114 employ high-speed serial links transmitted over external isolated channels, such as capacitive or inductive coupling structures, to maintain both safety isolation and communication performance. Multiple signal paths traverse the galvanically isolated barrier 106 between the first isolated transceiver 112 and the second isolated transceiver 114, enabling bidirectional communication between the edge domain 102 and the process domain 104.

The process domain 104 includes the second isolated transceiver 114 that receives serialized signals across the galvanically isolated barrier 106, reconstructs the original data stream, and routes the data to the process interface block 118. The process interface block 118 connects directly to application-specific components such as sensors, actuators, and power electronics. The modular separation between the edge domain 102 and the process domain 104 ensures that sensitive edge processing electronics within the edge domain 102 remain electrically isolated from high-voltage transients or fault conditions originating in the process domain 104.

The edge domain 102 and the process domain 104 are independently powered, ensuring that each domain may maintain operation during failure conditions in the other domain. In an example, separate analog ground connections on each side of the galvanically isolated barrier 106 maintain the isolation boundary between the edge domain 102 and the process domain 104.

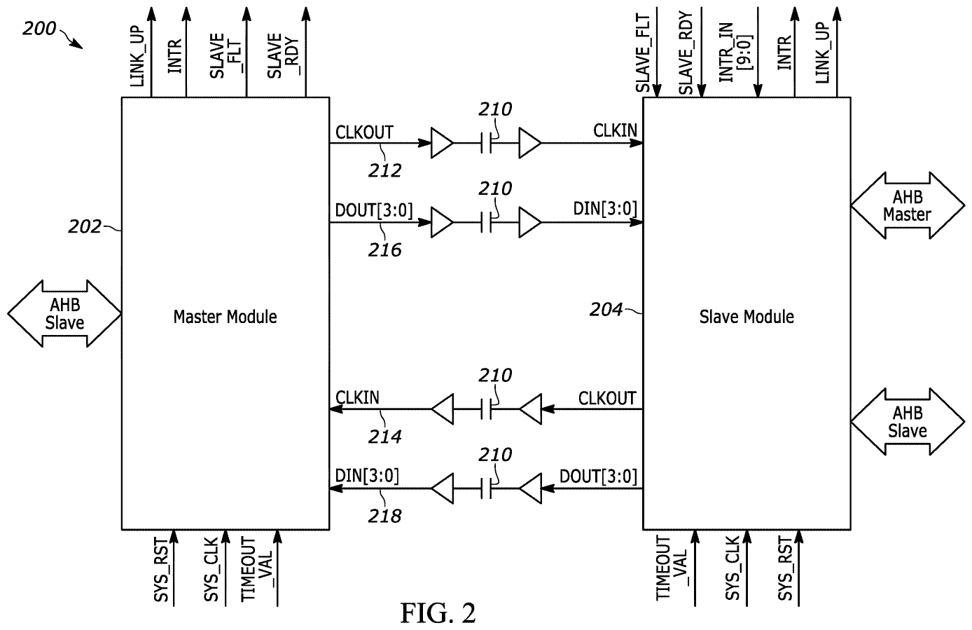

Referring to FIG. 2, a transceiver system 200 is configured for full-duplex, packet-based serial communication across a galvanically isolated interface. The transceiver system 200 includes a master module 202 positioned on the edge domain and a slave module 204 positioned on the process domain. The master module 202 and the slave module 204 communicate asynchronously over high-speed serial links to enable bidirectional data exchange while maintaining galvanic isolation between the two functional domains.

The master module 202 includes a first serializer-deserializer configured to serialize outgoing data packets and deserialize incoming data packets. The slave module 204 includes a second serializer-deserializer configured to serialize outgoing data packets and deserialize incoming data packets. The first serializer-deserializer and the second serializer-deserializer convert processed data into high-speed serial streams for transmission across the isolation barrier and reconstruct received serial streams into parallel data formats for processing within each respective domain. The master module 202 and the slave module 204 are configured to communicate via full-duplex communication, enabling simultaneous transmission and reception of data packets without requiring half-duplex switching or time-division multiplexing.

With continued reference to FIG. 2, the transceiver system 200 has two unidirectional signal paths for each direction of communication. A first unidirectional signal path includes a data output DOUT 216 from the master module 202 for transmitting data to the slave module 204. A second unidirectional signal path includes a data input DIN 218 at the master module 202 for receiving data from the slave module 204. The slave module 204 has corresponding data output DOUT 216 and data input DIN 218 connections that mirror the master module 202 configuration. The data output DOUT 216 and data input DIN 218 may carry multi-bit serial data, as indicated by the DOUT[3:0] and DIN[3:0] notation in FIG. 2.

Clock lines are transmitted in parallel with the data signals to support synchronous operation without requiring complex clock recovery logic. A clock output CLKOUT 212 from the master module 202 provides timing information to the slave module 204, and a clock input CLKIN 214 at the master module 202 receives timing information from the slave module 204. The parallel transmission of clock signals alongside data signals enables the receiving transceiver to sample incoming data at appropriate times without implementing phase-locked loops or other clock recovery circuits that would add complexity and latency to the communication path.

In an example, the master module 202 and the slave module 204 are configured to use Manchester encoding and at least one of On-Off Keying modulation and Amplitude Shift Keying modulation. Manchester encoding provides a self-clocking data format where each bit period contains a transition, enabling the receiver to maintain synchronization with the transmitted data stream. On-Off Keying modulation or Amplitude Shift Keying modulation modulates the data onto a radio frequency carrier for transmission across the isolation barrier. The combination of Manchester encoding with On-Off Keying or Amplitude Shift Keying provides robust signal transmission characteristics suitable for high-voltage isolation environments.

As further shown in FIG. 2, isolation barriers 210 are disposed between the master module 202 and the slave module 204. The isolation barriers 210 may be implemented using capacitive coupling structures or inductive coupling structures embedded within a printed circuit board. The capacitive coupling structures are represented by capacitor symbols in FIG. 2, indicating that signal transmission occurs through capacitive elements that block direct current paths while allowing alternating current signals to pass. The isolation barriers 210 maintain galvanic separation between the Edge Domain and the Process Domain while enabling high-speed serial communication.

In an example, the transceiver system 200 uses envelope detection, signal amplification, decoding, and synchronization on the receiver side to recover the original data stream. On the receiver side of each transceiver, the incoming modulated signal passes through envelope detection circuitry that extracts the amplitude variations representing the transmitted data. Signal amplification increases the detected signal level to appropriate values for subsequent processing. Decoding circuitry interprets the Manchester-encoded signal to recover the original bit stream. Synchronization circuitry aligns the recovered data with the local system clock for proper handoff to downstream processing blocks.

Built-in fault suppression features protect the front-end circuitry from electrical overstress and enhance noise immunity. The fault suppression features include echo cancellation that reduces interference from reflected signals within the communication path. Common-mode transient filters attenuate high-voltage transients that may couple across the isolation barrier during fault events in the Process Domain. The echo cancellation and common-mode transient filters enable the transceiver system 200 to maintain reliable communication even in electrically harsh environments where high-voltage transients and electromagnetic interference are present.

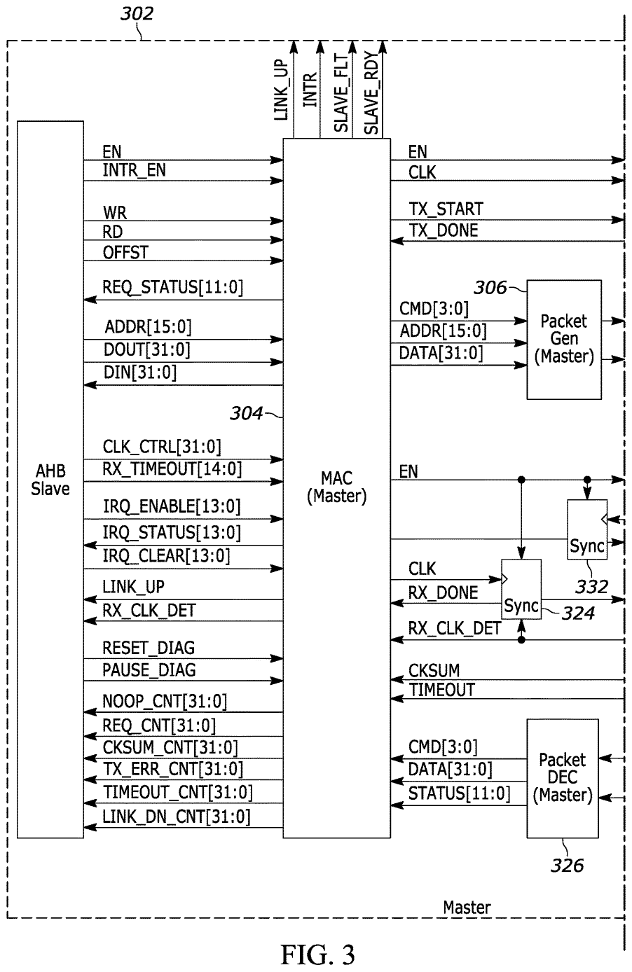

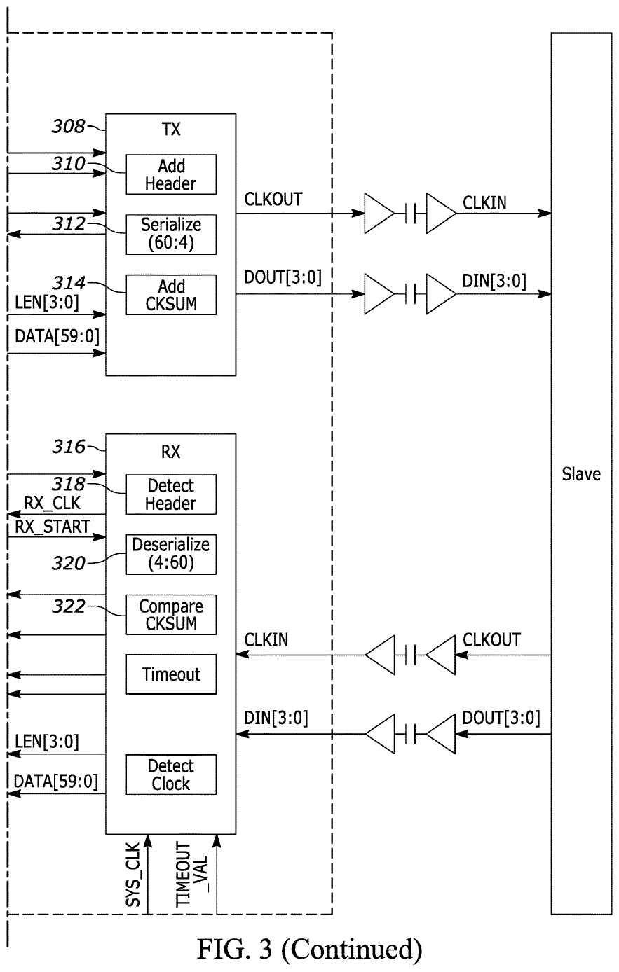

Referring to FIG. 3, a master transceiver module 302 is configured to reside on an edge domain and facilitate packet-based serial communication across a galvanically isolated barrier. As described previously, the edge domain includes an edge processing unit configured to execute diagnostic and networking functions, and a first fault handling subsystem configured to detect and respond to abnormal conditions. The master transceiver module 302 connects to an AHB Slave interface on one side, allowing external processors to initiate transactions with the master transceiver module 302. The AHB Slave interface enables the edge processing unit to read from and write to registers within the master transceiver module 302, configure communication parameters, and initiate data transfers to a slave transceiver module on the process domain.

The master transceiver module 302 includes a media access controller 304 that manages control signals, packet framing, and transmission logic. The media access controller 304 receives enable and clock signals and interfaces with synchronization logic within the master transceiver module 302. The media access controller 304 coordinates the operation of transmit and receive paths to enable full-duplex, packet-based serial communication across the galvanically isolated barrier. The media access controller 304 also manages handshaking between the AHB Slave interface and the internal packet processing blocks.

With continued reference to FIG. 3, the master transceiver module 302 includes a packet generator 306 configured to assemble request packets with command codes and data. The packet generator 306 receives command, address, data, and length information from the media access controller 304 and assembles these elements into request packets for transmission to the slave transceiver module. The packet generator 306 formats the request packets according to a defined packet structure that includes fields for command codes, target addresses, payload data, and packet length indicators. The assembled request packets are passed to a transmit path 308 for serialization and transmission across the isolation barrier.

The master transceiver module 302 includes a transmit path 308 including a header addition block 310, a serializer 312 configured to perform serialization, and a checksum addition block 314. The header addition block 310 prepends a packet header to each request packet received from the packet generator 306. The packet header may include synchronization patterns, packet type identifiers, and other framing information that enables the receiving slave transceiver module to detect and properly interpret incoming packets. The serializer 312 performs 60:4 serialization, converting 60-bit parallel data from the packet generator 306 into a 4-bit serial data stream for transmission across the galvanically isolated barrier. The 60:4 serialization ratio enables efficient use of the high-speed serial link while maintaining manageable parallel data widths within the master transceiver module 302. The checksum addition block 314 appends a checksum to each outgoing packet after serialization. The checksum enables the receiving slave transceiver module to verify data integrity and detect transmission errors.

As further shown in FIG. 3, the master transceiver module 302 further includes a receive path 316 including a header detection block 318, a deserializer 320, and a checksum comparison block 322. The header detection block 318 monitors incoming serial data from the slave transceiver module and identifies packet headers that indicate the start of valid response packets. The header detection block 318 uses pattern matching to recognize synchronization sequences and packet type identifiers within the incoming data stream. The deserializer 320 performs 4-bit to 60-bit deserialization, converting the incoming 4-bit serial data stream into a 60-bit parallel packet format for processing within the master transceiver module 302. The deserialization operation reverses the serialization performed by the slave transceiver module, reconstructing the original parallel data format. The checksum comparison block 322 validates received data integrity by comparing a received checksum against a locally computed checksum. The checksum comparison block 322 indicates whether each received packet passed or failed the integrity check, enabling the master transceiver module 302 to request retransmission of corrupted packets or flag communication errors.

The master transceiver module 302 includes a synchronization block 324 for clock detection and SYNC alignment. The synchronization block 324 handles clock synchronization using dedicated blocks for clock detection and SYNC alignment, enabling reliable decoding of asynchronous signals transmitted across the isolation barrier. The synchronization block 324 receives clock signals, receive done indicators, and receive clock detect signals from the receive path 316. The clock detection functionality identifies the presence and frequency of incoming clock signals from the slave transceiver module. The SYNC alignment functionality aligns the local sampling clock with transitions in the incoming data stream to maximize sampling margin and reduce bit errors. The synchronization block 324 interfaces with the receive path 316 to coordinate data recovery operations.

With continued reference to FIG. 3, a packet decoder 326 receives command, data, length, and status signals from the receive path 316 and extracts commands, addresses, and data for routing back to the AHB Slave interface. The packet decoder 326 parses the structure of received response packets to identify individual fields and their contents. The packet decoder 326 operates in conjunction with the media access controller 304 to process incoming response packets and make the extracted data available to the edge processing unit through the AHB Slave interface.

The master transceiver module 302 is configured to handle link integrity monitoring, interrupt generation, and slave-side status indicators. Link integrity monitoring is provided through a LINK_UP signal that indicates whether a valid communication link has been established with the slave transceiver module. The LINK_UP signal may be asserted when the master transceiver module 302 successfully exchanges packets with the slave transceiver module and de-asserted when communication failures are detected. Interrupt generation is provided through an INTR signal that notifies the edge processing unit of events requiring attention, such as received packets, communication errors, or status changes. The master transceiver module 302 provides slave-side status indicators including SLAVE_FLT for slave fault status indication and SLAVE_RDY for slave readiness indication. The SLAVE_FLT signal indicates when the slave transceiver module has detected an internal fault condition. The SLAVE_RDY signal indicates when the slave transceiver module is ready to accept commands and process transactions.

The master transceiver module 302 includes diagnostic counters for timeouts, transmission errors, checksum faults, and other runtime conditions, enabling in-field monitoring and predictive maintenance. The diagnostic counters may include a no-operation count, a request count, a checksum count, a transmit error count, a timeout count, and a link down count. The no-operation count tracks the number of no-operation commands processed. The request count tracks the total number of request packets transmitted. The checksum count tracks the number of checksum failures detected in received packets. The transmit error count tracks transmission errors encountered during packet transmission. The timeout count tracks the number of communication timeouts that occurred when expected responses were not received within a configured time window. The link down count tracks the number of times the communication link transitioned from an active state to an inactive state. These diagnostic counters enable system operators to monitor communication health, identify degrading link conditions, and schedule maintenance before failures occur. The diagnostic counters may be read through the AHB Slave interface and may be reset or paused through configuration registers.

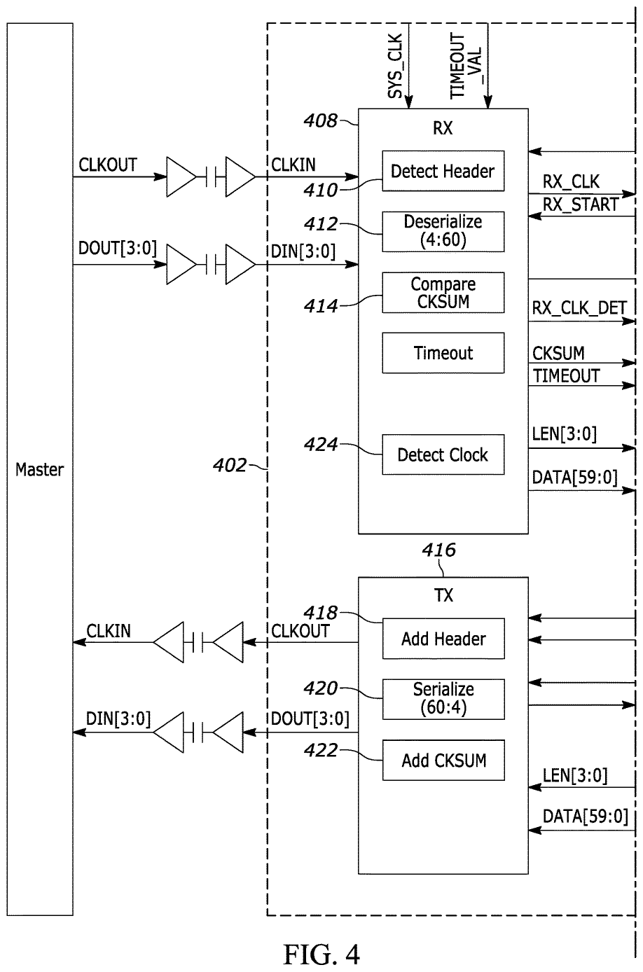

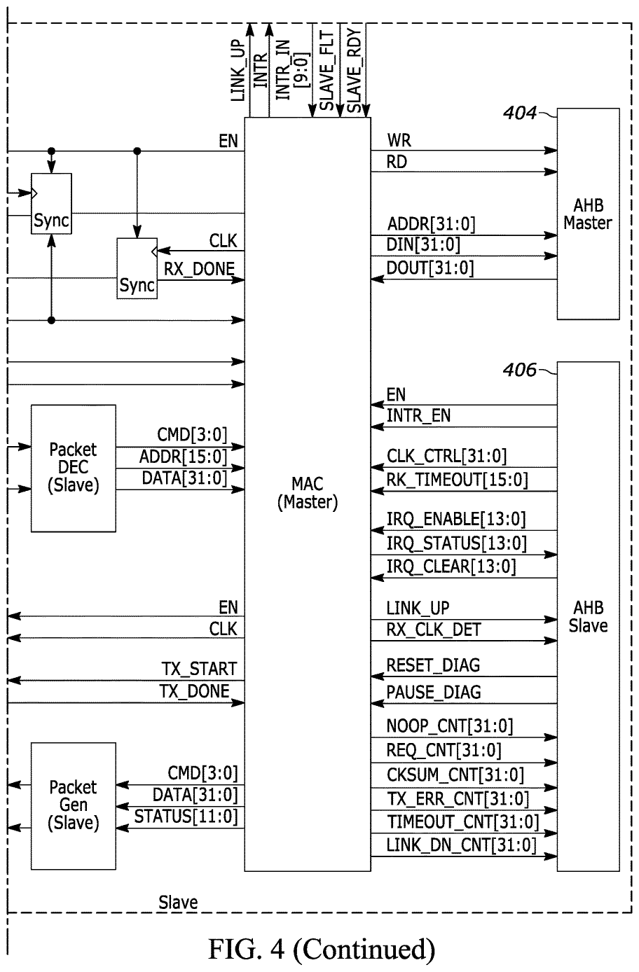

Referring to FIG. 4, a slave transceiver module 402 is configured to operate within the process domain and respond to incoming requests from the master transceiver module rather than initiating transactions. As described previously, the process domain includes a process interface configured to connect to at least one of sensors, actuators, and power electronics, and a second fault handling subsystem configured to detect and respond to abnormal conditions. The slave transceiver module 402 enables bidirectional communication across the galvanically isolated barrier while providing local control capabilities and external configuration options.

The slave transceiver module 402 interfaces with both an AHB master interface 404 and an AHB slave interface 406. The dual bus interface configuration enables the slave transceiver module 402 to control local hardware through the AHB master interface 404 and to be externally configured through the AHB slave interface 406. The AHB master interface 404 allows the slave transceiver module 402 to initiate transactions with local peripherals such as sensors, actuators, and other hardware components within the process domain. The AHB master interface 404 provides write, read, address, data input, and data output signals for communicating with local hardware. The AHB slave interface 406 allows external systems to configure the slave transceiver module 402 by writing to configuration registers and reading status information. The AHB slave interface 406 provides enable, interrupt enable, clock control, receive timeout, interrupt request enable, interrupt request status, and interrupt request clear signals for external configuration and monitoring.

With continued reference to FIG. 4, the slave transceiver module 402 includes a receive path 408 including a header detection block 410, a deserializer 412 configured to perform deserialization, and a checksum comparison block 414. The header detection block 410 monitors incoming serial data from the master transceiver module and identifies packet headers that indicate the start of valid request packets. The header detection block 410 uses pattern matching to recognize synchronization sequences and packet type identifiers within the incoming data stream from the master transceiver module. The deserializer 412 converts the incoming serial data stream into a parallel packet format for processing within the slave transceiver module 402. The deserialization operation reconstructs the original parallel data format from the serialized data transmitted by the master transceiver module. The checksum comparison block 414 validates received data integrity by comparing a received checksum against a locally computed checksum. The checksum comparison block 414 indicates whether each received packet passed or failed the integrity check, enabling the slave transceiver module 402 to discard corrupted packets or flag communication errors. The receive path 408 also includes a timeout detection block that monitors communication timing and detects when expected data is not received within a configured time window.

The slave transceiver module 402 further includes a transmit path 416 including a header addition block 418, a serializer 420, and a checksum addition block 422. Once a packet is validated and parsed by a packet decoder within the slave transceiver module 402, the slave transceiver module 402 executes the command locally and uses a packet generator to compose an acknowledgment or data response. The header addition block 418 prepends a packet header to each response packet. The packet header may include synchronization patterns, packet type identifiers, and other framing information that enables the receiving master transceiver module to detect and properly interpret incoming response packets. The serializer 420 converts parallel data from the packet generator into a serial data stream for transmission across the galvanically isolated barrier to the master transceiver module. The checksum addition block 422 appends a checksum to each outgoing response packet after serialization. The checksum enables the receiving master transceiver module to verify data integrity and detect transmission errors in the response packets.

As further shown in FIG. 4, the slave transceiver module 402 includes clock recovery logic for maintaining synchronization with incoming data from the master transceiver module. The clock recovery logic includes a clock detection block 424 that identifies the presence and characteristics of incoming clock signals. The clock recovery logic also includes synchronization circuitry that aligns local sampling operations with transitions in the incoming data stream. The clock recovery logic enables the slave transceiver module 402 to reliably decode asynchronous signals transmitted across the isolation barrier without requiring a shared physical clock between the edge domain and the process domain. The clock recovery logic interfaces with the receive path 408 to coordinate data recovery operations and indicate when reception is complete.

In an example, the slave transceiver module 402 is configured to receive status signals generated within the process domain, including a SLAVE_FLT signal and a SLAVE_RDY signal, for indicating operational state to an associated medium access control (MAC) layer. The SLAVE_FLT signal is asserted in response to detection of an internal fault condition by a fault handling subsystem, the fault condition including, but not limited to, abnormal electrical conditions, abnormal thermal conditions, or other monitored anomalies. The SLAVE_RDY signal is asserted to indicate that the process domain is initialized and capable of accepting commands and process transactions. The slave transceiver module 402 communicates the SLAVE_FLT and SLAVE_RDY signals to the master transceiver module via a serialized communication link extending across a galvanically isolated barrier, the signals being encoded within the communication stream to enable monitoring of process-domain status by an edge-domain controller without requiring additional isolated signaling paths.

In an example, the slave transceiver module 402 includes diagnostic counters and configuration registers that enable detailed local control and monitoring. The diagnostic counters may include a no-operation count, a request count, a checksum count, a transmit error count, a timeout count, and a link down count. These diagnostic counters track communication statistics and error conditions within the slave transceiver module 402. The configuration registers allow external systems to configure operating parameters of the slave transceiver module 402 through the AHB slave interface 406. The slave transceiver module 402 operates deterministically under real-time constraints while maintaining isolation from the edge domain through the galvanically isolated barrier.

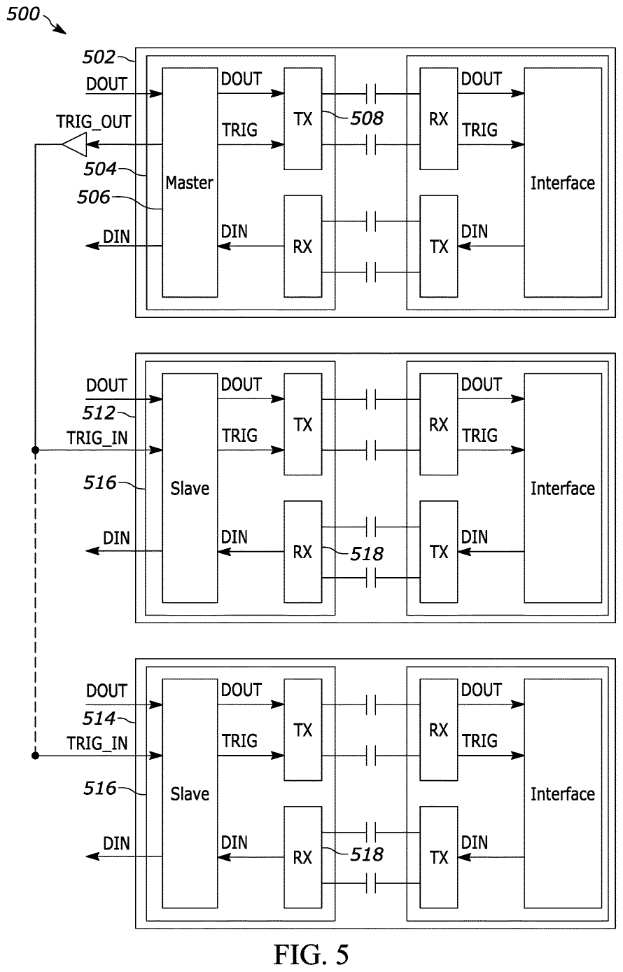

Referring to FIG. 5, a synchronization mechanism 500 for multiple isolated interfaces is illustrated. The synchronization mechanism 500 is configured to coordinate operation across an edge domain and a process domain by encoding a trigger signal within a serial communication protocol. The synchronization mechanism 500 enables deterministic coordination between a master subsystem 502 and a plurality of slave subsystems 512, 514, all of which are physically and electrically isolated but logically coordinated for coherent operation.

The master subsystem 502 includes a master transceiver 504 with an internal trigger logic block 506 configured to generate a trigger pulse. The internal trigger logic block 506 generates a trigger pulse designated as TRIG_OUT upon a software-defined event or a hardware-defined event. The trigger pulse may be initiated by the edge processing unit in response to a timing requirement, an external stimulus, or a programmed schedule. The internal trigger logic block 506 provides the origination point for synchronization signals that propagate to the plurality of slave subsystems 512, 514.

With continued reference to FIG. 5, the master transceiver 504 includes a transmit block 508 configured to encode the trigger pulse into a preamble or header of an outgoing data packet. The transmit block 508 receives the trigger pulse from the internal trigger logic block 506 and incorporates the trigger pulse into the next outgoing data packet. The encoding of the trigger pulse within the packet preamble or packet header enables the transmission of the synchronization signal to carry both data and a synchronization signal within a single packet structure. The transmit block 508 serializes the outgoing data packet including the encoded trigger pulse and transmits the serialized data across the galvanically isolated barrier to the plurality of slave subsystems 512, 514.

The plurality of slave subsystems 512, 514 are positioned below the master subsystem 502 in FIG. 5. Each slave subsystem includes a slave transceiver 516 with a receive block 518 configured to detect the trigger pulse from an incoming data packet and assert a local trigger input signal. The receive block 518 within each slave transceiver 516 monitors incoming serial data from the master subsystem 502 and identifies the trigger pulse encoded within the packet preamble or packet header. Upon recognizing the trigger portion in the incoming packet, the receive block 518 asserts a local trigger input signal designated as TRIG\_IN. The local trigger input signal propagates internally within each slave subsystem to initiate a time-aligned operation.

As further shown in FIG. 5, the master subsystem 502 and the slave subsystems 512, 514 include a galvanically isolated barrier to maintain electrical separation between the different voltage domains while enabling high-speed serial communication. The galvanically isolated barrier may be implemented using capacitive coupling structures or inductive coupling structures as described previously. Interface modules facilitate communication across the galvanically isolated barrier, with each interface module containing transmit and receive blocks that mirror the transceiver configurations.

The master subsystem 502 and the plurality of slave subsystems 512, 514 are configured to achieve deterministic synchronization across the galvanically isolated barrier without a shared physical clock. Because the synchronization signal is encoded within the packet rather than transmitted as a separate analog or digital signal line, the synchronization mechanism 500 maintains full galvanic isolation between all subsystems. Each slave subsystem independently decodes the trigger signal from the packet preamble received through the galvanically isolated barrier, eliminating the need for centralized clock distribution or non-isolated trigger lines that would compromise safety isolation.

The synchronization mechanism 500 is scalable to coordinate operation across a plurality of slave subsystems 512, 514. The master subsystem 502 may distribute the TRIG_OUT signal to multiple slave subsystems 512, 514 by replicating the trigger-encoded packets to all connected slave subsystems. Each slave subsystem independently decoding the trigger signal from a packet preamble ensures distributed synchronization without requiring a shared physical clock. The scalability enables coordination across complex distributed systems with numerous isolated measurement or control nodes.

With continued reference to FIG. 5, the synchronization mechanism 500 provides deterministic latency between generation of the trigger signal and detection of the trigger signal. The deterministic latency is governed by serialization delay and transmission delay of the serial communication protocol. The serialization delay corresponds to the time required for the transmit block 508 to convert the parallel packet data including the encoded trigger pulse into a serial data stream. The transmission delay corresponds to the time required for the serialized data to propagate across the galvanically isolated barrier and reach the receive block 518 within each slave subsystem. Because both the serialization delay and the transmission delay are known and consistent, the latency between trigger generation at the master subsystem 502 and trigger detection at each slave subsystem remains deterministic and predictable.

The first isolated transceiver and the second isolated transceiver of each subsystem are configured to support full-duplex communication while honoring synchronized triggers. The architecture supports full-duplex communication where each subsystem continues to exchange data independently while still honoring synchronized triggers. Each slave subsystem maintains transmit and receive paths, and the isolated communication remains bidirectional. Slave subsystems 512, 514 may respond with acknowledgment packets or telemetry data even as the slave subsystems 512, 514 execute triggered tasks. The full-duplex capability enables continuous data exchange without interrupting synchronization operations.

The synchronization mechanism 500 supports synchronized timestamping, coordinated measurements, or simultaneous actuation for applications requiring nanosecond-to-microsecond precision. The deterministic latency characteristics enable precise timing alignment across multiple measurement channels or control outputs. Synchronized timestamping allows events detected at different slave subsystems to be correlated with a common time reference established by the master subsystem 502 trigger. Coordinated measurements enable simultaneous data acquisition across distributed sensors for applications requiring phase-coherent sampling. Simultaneous actuation enables multiple actuators to respond to a common trigger event with minimal timing skew.

The synchronization mechanism 500 supports applications such as three-phase power analysis, motor control, or protective relaying. In three-phase power analysis applications, the synchronization mechanism 500 enables accurate phase angle measurements and harmonic analysis by coordinating sampling across voltage and current channels associated with each phase. In motor control applications, the synchronization mechanism 500 enables coordinated control of multiple motor drives or synchronized feedback acquisition from distributed position sensors. In protective relaying applications, the synchronization mechanism 500 enables coordinated fault detection and isolation across multiple measurement points within a power distribution network.

As described previously, the transceivers support asynchronous full-duplex communication with echo cancellation optimized for high-voltage environments. The echo cancellation reduces interference from reflected signals within the communication path, enabling reliable communication even when high-voltage transients or electromagnetic interference are present. The combination of asynchronous communication, full-duplex capability, and echo cancellation provides robust signal transmission characteristics suitable for electrically harsh environments, such as those encountered in industrial, automotive, energy infrastructure, medical, telecommunications, and aerospace applications, among others.

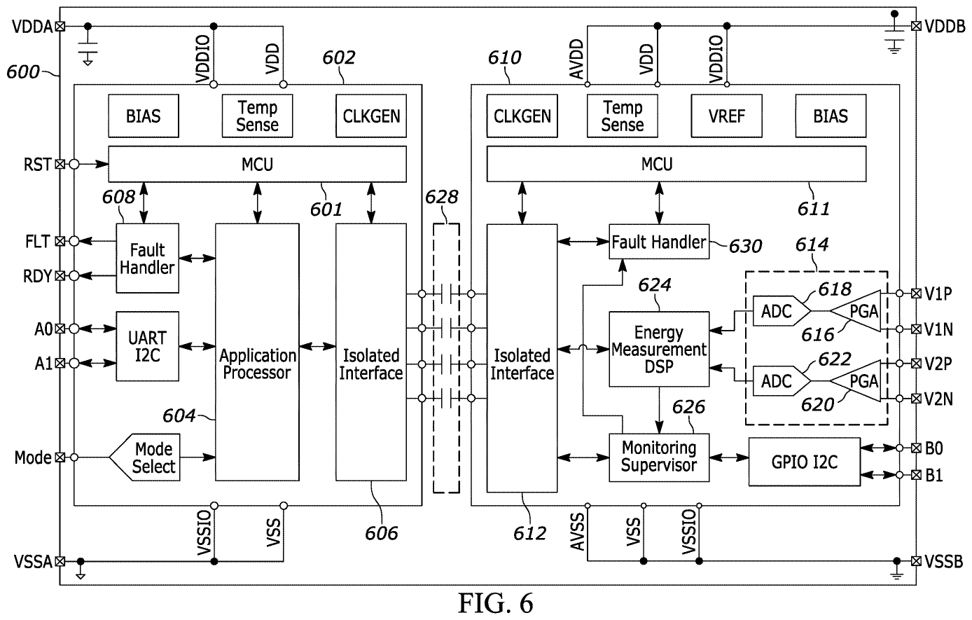

Referring to FIG. 6, an isolated energy meter system 600 is implemented using the Edge Safety Interface architecture. The isolated energy meter system 600 is partitioned into two distinct domains separated by a galvanic isolation channel 628: a host-side domain 602 and a process-side measurement domain 610. The galvanic isolation channel 628 is disposed between the host-side domain 602 and the process-side measurement domain 610, providing galvanic separation while enabling bidirectional serial communication between the two domains.

The host-side domain 602 includes a host processor 604 and a first isolated transceiver 606. The host processor 604 may be implemented as a microcontroller unit that provides processing capabilities for configuration, data logging, and communication with external systems. The host-side domain 602 also includes a fault handler 608 configured to detect and respond to abnormal conditions within the host-side domain 602. The first isolated transceiver 606 facilitates communication across the galvanic isolation channel 628 to the process-side measurement domain 610. The host-side domain 602 may include support circuitry such as a bias circuit, a temperature sense block, and a clock generation circuit.

With continued reference to FIG. 6, the process-side measurement domain 610 includes a second isolated transceiver 612, an analog front-end 614 including a plurality of programmable gain amplifiers and a plurality of analog-to-digital converters, an energy measurement digital signal processor 624, and a monitoring supervisor 626. The first isolated transceiver 606 and the second isolated transceiver 612 are configured to communicate via serial communication across the galvanic isolation channel 628. The process-side measurement domain 610 is configured to be powered independently from the host-side domain 602. The energy measurement digital signal processor 624 is configured to be powered from a measured power line, ensuring continued functionality even under external power loss on the host side. This independent powering arrangement enables the process-side measurement domain 610 to continue monitoring and recording power parameters even when the host-side domain 602 loses power.

The analog front-end 614 includes two measurement channels for sensing voltage and current. A first measurement channel includes a first programmable gain amplifier 616 connected to a first analog-to-digital converter 618, with the first measurement channel receiving differential voltage inputs for voltage sensing. A second measurement channel includes a second programmable gain amplifier 620 connected to a second analog-to-digital converter 622, with the second measurement channel receiving differential current inputs for current sensing. The programmable gain amplifiers condition the sensed signals by providing adjustable amplification to accommodate different input signal ranges. The analog-to-digital converters digitize the conditioned signals for processing by the energy measurement digital signal processor 624.

As further shown in FIG. 6, the energy measurement digital signal processor 624 executes real-time computations to extract power and energy metrics from the digitized voltage and current samples. The energy measurement digital signal processor 624 is configured to compute at least one of RMS voltage, RMS current, real power, reactive power, and power factor. The RMS voltage and RMS current computations provide root-mean-square values of the sensed voltage and current waveforms. The real power computation determines the actual power consumed by a load. The reactive power computation determines the power associated with energy storage elements in the load. The power factor computation determines the ratio of real power to apparent power, indicating the efficiency of power utilization.

The energy measurement digital signal processor 624 is configured to compute at least one of harmonic content and transient events. The harmonic content computation analyzes the frequency spectrum of the voltage and current waveforms to identify harmonic distortion components at multiples of the fundamental power frequency. The transient event computation detects and characterizes sudden changes in voltage or current that may indicate fault conditions or load switching events. These computations enable comprehensive power quality monitoring beyond basic energy measurement.

With continued reference to FIG. 6, the monitoring supervisor 626 oversees the computed parameters from the energy measurement digital signal processor 624 and identifies anomalies or violations of programmable threshold limits. The monitoring supervisor 626 is configured to detect anomalies by comparing computed parameters against programmable threshold limits. The programmable threshold limits may be configured for various parameters including voltage magnitude, current magnitude, power factor, and harmonic distortion levels. When a computed parameter exceeds or falls below a corresponding programmable threshold limit, the monitoring supervisor 626 identifies the condition as an anomaly requiring attention or response.

The monitoring supervisor 626 is configured to autonomously trigger a fault response upon detecting a deviation from the programmable threshold limits. The fault response may include at least one of system shutdown and relay trip. The monitoring supervisor 626 is configured to autonomously trigger a fault response upon detecting a deviation indicative of at least one of sustained overcurrent, voltage imbalance, and harmonic distortion. Sustained overcurrent conditions may indicate overloaded circuits or short-circuit faults. Voltage imbalance conditions may indicate problems with power supply or distribution equipment. Harmonic distortion conditions may indicate the presence of nonlinear loads that degrade power quality. The autonomous fault response capability enables the isolated energy meter system 600 to protect connected equipment and personnel without requiring intervention from the host processor 604 or external systems.

In an example, the monitoring supervisor 626 incorporates machine learning configured to detect abnormal patterns indicative of at least one of a fault and a threat. The machine learning capability enables the monitoring supervisor 626 to identify complex patterns in the computed parameters that may not be detectable through simple threshold comparisons. The abnormal patterns are programmable through the galvanic isolation channel 628 for various application conditions. Different patterns may be programmed for different operating environments, load types, or threat scenarios. The programmability of the abnormal patterns enables the isolated energy meter system 600 to be adapted to specific application requirements without hardware modifications.

In an example, the isolated energy meter system 600 is integrated with a master controller using at least one of UART and I2C protocols, enabling remote configuration and fault monitoring. The host-side domain 602 connects to an application processor through a UART or I2C interface, allowing external systems to communicate with the isolated energy meter system 600. The programmable threshold settings, mode selection, and fault handling strategies may be dynamically adjusted via a host interface provided by the host-side domain 602. This remote configuration capability enables system operators to modify operating parameters and fault response behaviors without physical access to the isolated energy meter system 600.

In an example, the first isolated transceiver 606 and the second isolated transceiver 612 are configured to communicate via a high-speed serial interface. The high-speed serial interface enables rapid data exchange between the host-side domain 602 and the process-side measurement domain 610 while maintaining galvanic separation through the isolation channel. The high-speed serial interface supports the bandwidth requirements for transmitting computed power and energy metrics, configuration commands, and diagnostic information between the two domains. The serial interface architecture reduces the number of signal paths that traverse the isolation barrier compared to parallel communication approaches, simplifying the isolation channel design while maintaining adequate data throughput.

The first isolated transceiver 606 and the second isolated transceiver 612 are configured to use Manchester encoding and clock recovery. Manchester encoding provides a self-clocking data format where each bit period contains a transition, enabling the receiving transceiver to maintain synchronization with the transmitted data stream without requiring a separate clock signal path across the isolation barrier. The clock recovery functionality within each isolated transceiver extracts timing information from the Manchester-encoded data stream to reconstruct a local sampling clock. The clock recovery circuitry tracks transitions in the incoming data stream and generates a recovered clock signal that aligns with the transmitted data timing. The combination of Manchester encoding and clock recovery enables reliable asynchronous communication across the galvanic isolation channel 628 without requiring phase-locked loops or other complex clock synchronization circuits that would add latency and design complexity.

The galvanic isolation channel 628 includes at least one of capacitive coupling and inductive coupling with ground shielding structures. As described previously, capacitive coupling structures may be formed using overlapping plates within a multilayer printed circuit board, with the overlapping plates positioned on different layers and separated by dielectric material. Inductive coupling structures may be formed using overlapping loops within the multilayer printed circuit board, with magnetic coupling between the loops enabling signal transmission. The ground shielding structures surround the capacitive coupling structures or the inductive coupling structures within the printed circuit board. The ground shielding structures suppress electromagnetic interference by attenuating external noise that could couple into the signal paths and by reducing emissions from the coupling structures. The ground shielding structures also provide protection against environmental degradation of the isolation channel.

The host-side domain 602 is configured to integrate with a master controller via at least one of UART and I2C protocols. The UART protocol provides asynchronous serial communication with configurable baud rates, enabling the master controller to exchange data with the host-side domain 602 without requiring a shared clock signal. The I2C protocol provides a two-wire synchronous serial interface that supports multiple devices on a shared bus, enabling the master controller to communicate with the isolated energy meter system 600 alongside other peripheral devices. The integration with the master controller enables external systems to configure operating parameters, retrieve computed power and energy metrics, and monitor fault status of the isolated energy meter system 600.

The host-side domain 602 is configured to provide programmable threshold settings via a host interface. The host interface enables the master controller to write threshold values to configuration registers within the host-side domain 602. The threshold values are communicated across the galvanic isolation channel 628 to the monitoring supervisor 626 in the process-side measurement domain 610. The programmable threshold settings may include limits for voltage magnitude, current magnitude, power factor, harmonic distortion levels, and other computed parameters. The ability to program threshold settings via the host interface enables system operators to adapt the fault detection behavior of the isolated energy meter system 600 to specific application requirements without hardware modifications.

The isolated energy meter system 600 may further include isolated general-purpose input/output interfaces for local control. The isolated general-purpose input/output interfaces provide additional connectivity for local control functions or expansion with other supervisory or relay logic. The isolated general-purpose input/output interfaces may be used to control external relays, read status inputs from external equipment, or interface with other monitoring systems. The isolated general-purpose input/output interfaces maintain galvanic isolation between the process-side measurement domain 610 and external circuits, extending the isolation boundary beyond the primary measurement and communication functions.

The analog front-end 614 includes differential inputs for voltage sensing and current sensing. The differential inputs for voltage sensing receive voltage signals from a resistor divider network connected across the power line being measured. The differential inputs for current sensing receive voltage signals developed across a shunt resistor or current transformer in series with the load current path. The differential input configuration rejects common-mode noise and interference that may be present on both input terminals, improving measurement accuracy in electrically noisy environments. The differential inputs connect to the plurality of programmable gain amplifiers, which condition the sensed signals before digitization.

In an example, the plurality of analog-to-digital converters include high-resolution analog-to-digital converters. The high-resolution analog-to-digital converters provide sufficient bit depth to accurately represent the voltage and current waveforms across the full dynamic range of expected input signals. The high resolution enables the energy measurement digital signal processor 624 to compute power and energy metrics with precision adequate for billing-grade metering applications and detailed power quality analysis. The high-resolution analog-to-digital converters may provide resolution of sixteen bits or greater, depending on the accuracy requirements of the specific application.

The host-side domain 602 includes a host microcontroller unit 601, the fault handler 608, and the first isolated interface 606. The host microcontroller unit 601 provides processing capabilities for managing communication with the master controller, storing configuration parameters, and coordinating data exchange with the process-side domain 610. The fault handler 608 in the host-side domain 602 detects and responds to abnormal conditions within the host-side domain 602, such as communication failures or power supply anomalies. The first isolated interface facilitates communication across the galvanic isolation channel 628.

The host-side domain 602 further includes at least one of a bias circuit, a temperature sense block, and a clock generation circuit. The bias circuit provides stable reference currents and voltages for analog circuits within the host-side domain 602. The temperature sense block monitors the temperature of the host-side domain 602 circuitry, enabling temperature compensation of sensitive circuits and detection of thermal anomalies. The clock generation circuit produces clock signals for the host microcontroller unit 604 and other digital circuits within the host-side domain 602.

The process-side domain 610 includes the second isolated interface 612, a process microcontroller unit 611, a fault handler 630, the energy measurement digital signal processor 624, the plurality of programmable gain amplifiers connected to differential voltage inputs and differential current inputs, the plurality of analog-to-digital converters connected to the plurality of programmable gain amplifiers, and the monitoring supervisor 626 configured to detect anomalies and trigger fault responses. The process microcontroller unit 611 coordinates operation of the analog front-end 614, the energy measurement digital signal processor 624, and the second isolated interface. The fault handler 630 in the process-side domain 610 detects and responds to abnormal conditions within the process-side domain 610.

The process-side domain 610 further includes at least one of a bias circuit, a temperature sense block, a voltage reference, and a clock generation circuit. The bias circuit in the process-side domain 610 provides stable reference currents and voltages for the analog front-end 614 circuitry. The temperature sense block in the process-side domain 610 monitors the temperature of the process-side circuitry, enabling temperature compensation of the analog-to-digital converters and other temperature-sensitive components. The voltage reference provides a stable reference voltage for the analog-to-digital converters, establishing the full-scale input range and ensuring consistent measurement accuracy. The clock generation circuit in the process-side domain 610 produces clock signals for the process microcontroller unit, the energy measurement digital signal processor 624, and the analog-to-digital converters.

The galvanic isolation channel 628 disposed between the host-side domain 602 and the process-side domain 610 includes at least one of capacitive coupling structures and inductive coupling structures. The capacitive coupling structures or inductive coupling structures enable high-speed serial communication between the first isolated interface and the second isolated interface while maintaining electrical separation between the two domains. The isolation channel design supports the voltage isolation requirements of the specific application, which may include compliance with safety standards for high-voltage environments.

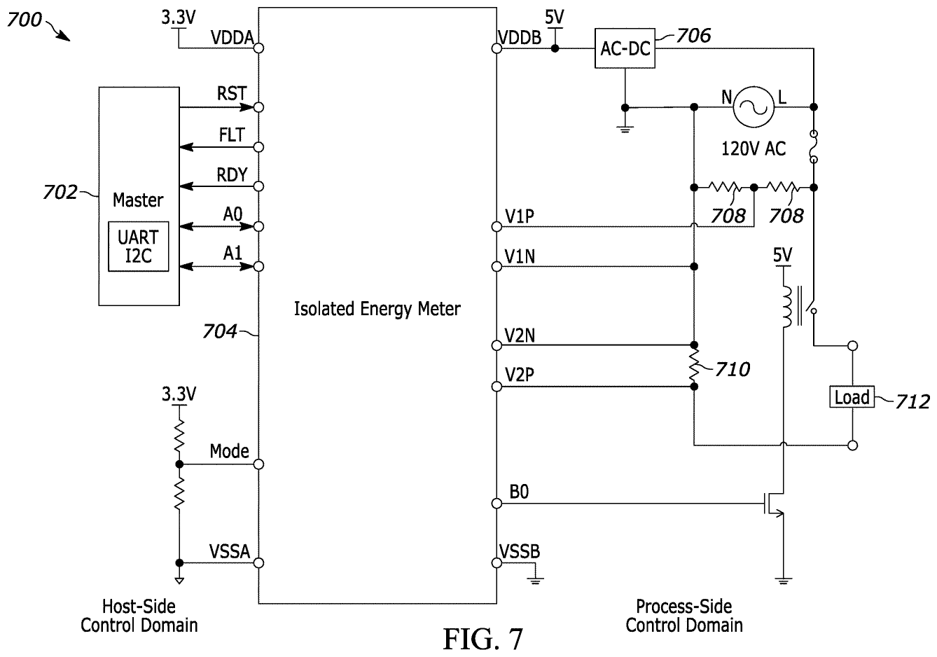

Referring to FIG. 7, an application circuit 700 illustrates a single-phase power measurement configuration using the isolated energy meter system. The application circuit 700 demonstrates galvanic isolation between a host-side control domain positioned on the left side of the circuit and a process-side measurement domain positioned on the right side of the circuit. An isolated energy meter block 704 provides the galvanic barrier between these two domains while enabling measurement of voltage and current parameters and communication of computed energy metrics. In an example, the isolated energy meter block may include an edge safety interface similar to that described with reference to FIG. 1-6.

On the host-side control domain, a master controller 702 with UART and I2C capability connects to the isolated energy meter block 704 through multiple signal lines. The master controller 702 operates from a 3.3V supply and interfaces with the isolated energy meter block 704 through communication pins for bidirectional data exchange. A reset pin (RST) provides system reset functionality, a fault indication pin (FLT) provides notification of fault conditions detected within the isolated energy meter block 704, and a ready status pin (RDY) indicates operational readiness of the process-side measurement domain. Address lines enable the master controller 702 to communicate with the isolated energy meter block 704 using UART or I2C protocols. A mode pin connects through a resistor divider network to the 3.3V supply, allowing configuration of the operating mode of the isolated energy meter block 704. An analog ground reference pin provides the ground reference for the host-side control domain.

With continued reference to FIG. 7, the process-side measurement domain interfaces with an AC power line and a load 712. The process-side measurement domain operates from a 5V supply derived from an AC-DC converter block 706 that draws power from the AC source. The AC source includes neutral and line connections, with the line connection passing through the circuit to the load 712 positioned on the right side of the circuit.

The voltage sensing path utilizes differential voltage input pins that connect to a resistor divider network tied across the AC line. The resistor divider network scales the line voltage to levels suitable for the analog front-end inputs of the isolated energy meter block 704. The resistor divider network includes resistors 708 that divide the AC line voltage to produce a reduced voltage signal proportional to the line voltage. The reduced voltage signal is applied to the differential voltage inputs of the isolated energy meter block 704, where the programmable gain amplifiers and analog-to-digital converters digitize the voltage waveform for processing by the energy measurement digital signal processor.

As further shown in FIG. 7, the current sensing path utilizes differential current input pins that connect across a shunt resistor 710 placed in series with the load 712 on the line conductor. The shunt resistor 710 develops a voltage proportional to the current flowing through the load 712. The voltage developed across the shunt resistor 710 is applied to the differential current inputs of the isolated energy meter block 704. The programmable gain amplifiers condition the current sense signal, and the analog-to-digital converters digitize the current waveform for processing by the energy measurement digital signal processor. The shunt resistor 710 configuration enables direct measurement of load current without requiring current transformers or other magnetic sensing elements.

The circuit layout demonstrates the separation between the low-voltage host-side control domain operating at 3.3V and the process-side measurement domain operating at 5V while interfacing with 120V AC mains. The isolated energy meter block 704 provides the galvanic barrier between these domains, enabling the master controller 702 to configure operating parameters, retrieve computed power and energy metrics, and monitor fault status while remaining electrically isolated from the high-voltage AC power circuit.

The isolated energy meter block 704 is suitable for data center power quality monitoring applications. In data center environments, the isolated energy meter block 704 enables continuous monitoring of power consumption across multiple server racks and power distribution units. The galvanic isolation between the host-side control domain and the process-side measurement domain allows data center operators to connect the isolated energy meter block 704 to information technology networking equipment without introducing electrical paths between the high-voltage power infrastructure and sensitive computing systems. The master controller 702 connection via UART or I2C protocols enables integration with data center management systems for real-time visibility into power consumption, anomaly detection, and predictive maintenance strategies.

The isolated energy meter block 704 is suitable for electric vehicle charging infrastructure applications. In electric vehicle charging environments, the isolated energy meter block 704 provides measurement capabilities for monitoring power delivery to charging stations while maintaining galvanic isolation between the charging power electronics and edge computing systems that manage billing, authentication, and grid communication. The monitoring supervisor capabilities enable autonomous detection and response to overcurrent conditions, voltage imbalances, or other electrical hazards that may occur during charging operations.

The isolated energy meter block 704 is suitable for industrial control systems applications. In industrial environments, the isolated energy meter block 704 enables power quality monitoring for manufacturing equipment, motor drives, and other industrial loads operating in electrically harsh conditions. The enhanced distance-through-insulation and embedded ground shielding provide robust protection against electromagnetic interference and high-voltage transients commonly encountered in manufacturing facilities.

The Edge Safety Interface architecture is suitable for battery management systems for energy storage applications. In battery management applications, the galvanic isolation between the host-side domain and the process-side measurement domain enables monitoring of individual battery modules while maintaining electrical separation between each module and a central management controller. The synchronization mechanism enables coordinated monitoring and control across multiple battery modules while maintaining galvanic isolation. The ability to embed trigger signals within the serial communication protocol allows for deterministic, time-aligned data acquisition across distributed battery cells, which supports accurate state-of-charge estimation and thermal management across battery arrays.

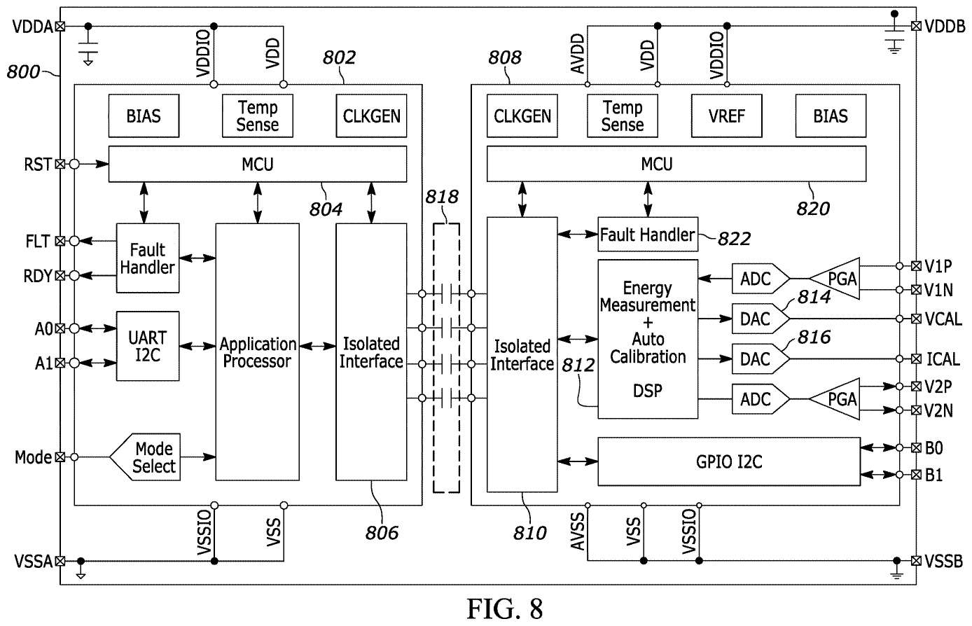

Referring to FIG. 8, an isolated energy meter system with auto-calibration 800 is illustrated. The isolated energy meter system with auto-calibration 800 is partitioned into two distinct domains separated by a galvanic isolation channel 818: a host-side domain 802 and a process-side domain 808. The galvanic isolation channel 818 is disposed between the host-side domain 802 and the process-side domain 808, providing galvanic separation while enabling bidirectional serial communication between the two domains.

The host-side domain 802 includes a host microcontroller unit 804 and a first isolated interface 806. The host microcontroller unit 804 provides processing capabilities for configuration, data logging, and communication with external systems. The first isolated interface 806 facilitates communication across the galvanic isolation channel 818 to the process-side domain 808. The host-side domain 802 may include support circuitry such as a bias block, a temperature sense block, and a clock generation block. A fault handler in the host-side domain 802 detects and responds to abnormal conditions within the host-side domain 802.

With continued reference to FIG. 8, the process-side domain 808 includes a second isolated interface 810, an energy measurement and auto-calibration digital signal processor 812, a plurality of programmable gain amplifiers connected to differential voltage inputs and differential current inputs, and a plurality of analog-to-digital converters connected to the plurality of programmable gain amplifiers. The process-side domain 808 also includes a voltage digital-to-analog converter 814 configured to output a voltage calibration signal to a voltage calibration output, and a current digital-to-analog converter 816 configured to output a current calibration signal to a current calibration output. The process-side domain 808 may include support circuitry such as a bias block, a temperature sense block, a voltage reference, and a clock generation block. A process microcontroller unit 820 and a fault handler 822 coordinate operation within the process-side domain 808.

The process-side domain 808 includes an analog front-end with a voltage sensing path and a current sensing path. The voltage sensing path includes a first programmable gain amplifier connected to differential voltage inputs and a first analog-to-digital converter connected to the first programmable gain amplifier. The current sensing path includes a second programmable gain amplifier connected to differential current inputs and a second analog-to-digital converter connected to the second programmable gain amplifier. The programmable gain amplifiers condition the sensed signals by providing adjustable amplification to accommodate different input signal ranges. The analog-to-digital converters digitize the conditioned signals for processing by the energy measurement and auto-calibration digital signal processor 812.

As further shown in FIG. 8, the voltage digital-to-analog converter 814 is configured to inject a first calibration signal into the voltage sensing path. The current digital-to-analog converter 816 is configured to inject a second calibration signal into the current sensing path. The first calibration signal and the second calibration signal include pseudo-random calibration signals occupying a frequency band higher than a fundamental power frequency and harmonics thereof. The fundamental power frequency may be 50 Hz or 60 Hz depending on the geographic region of deployment. The frequency band of the first calibration signal and the second calibration signal is separated from the fundamental power frequency to ensure no interference with energy measurement. The frequency separation ensures that the injected calibration signals do not corrupt or distort the actual power and energy measurements being performed by the energy measurement and auto-calibration digital signal processor 812.

In an example, the voltage calibration signal and the current calibration signal include pseudo-random signals at a frequency band higher than a fundamental power frequency. The pseudo-random nature of the calibration signals provides a known signature that the energy measurement and auto-calibration digital signal processor 812 may use to identify and extract the calibration signals from composite signals that include both actual measurement signals and the injected calibration signals. The first calibration signal and the second calibration signal are injected in parallel with actual measurement signals from a power line. The parallel injection ensures that the calibration signals traverse the same sensing path as actual measurements, exercising the full signal chain including the programmable gain amplifiers and the analog-to-digital converters during calibration operations.

With continued reference to FIG. 8, the energy measurement and auto-calibration digital signal processor 812 is configured to isolate the first calibration signal and the second calibration signal from measurement signals and dynamically adjust compensation to correct sensor drift. The energy measurement and auto-calibration digital signal processor 812 is configured to employ digital filtering and spectral separation techniques to isolate the pseudo-random calibration signals from the measurement signals. The digital filtering suppresses the energy frequency content associated with the fundamental power frequency and harmonics thereof, isolating the pseudo-random calibration signals for analysis. The spectral separation techniques exploit the frequency band separation between the calibration signals and the measurement signals to distinguish between the two signal components within the composite digitized signal.

The energy measurement and auto-calibration digital signal processor 812 includes an auto-calibration module configured to extract and quantify at least one of distortion and gain error from a composite signal. The auto-calibration module compares the received calibration signals with expected signatures corresponding to the known pseudo-random calibration signals that were injected by the voltage digital-to-analog converter 814 and the current digital-to-analog converter 816. Differences between the received calibration signals and the expected signatures indicate gain deviations and offset deviations introduced by the voltage sensing path and the current sensing path. The auto-calibration module uses these computed deviations to dynamically adjust compensation algorithms within the energy measurement and auto-calibration digital signal processor 812, thereby correcting sensor drift and maintaining measurement accuracy.

The voltage digital-to-analog converter 814 and the current digital-to-analog converter 816 are controlled by at least one of the host microcontroller unit 804 and the energy measurement and auto-calibration digital signal processor 812. The control of the digital-to-analog converters enables generation of the pseudo-random calibration sequences that are injected into the sensing paths. The host microcontroller unit 804 may initiate calibration operations or configure calibration parameters through the galvanic isolation channel 818. The energy measurement and auto-calibration digital signal processor 812 may autonomously control the digital-to-analog converters to perform continuous calibration operations without requiring intervention from the host-side domain 802.

The auto-calibration approach enables in-field recalibration supporting long-term accuracy and system reliability even under varying environmental or load conditions. The continuous injection and monitoring of calibration signals allows the isolated energy meter system with auto-calibration 800 to detect and correct for aging effects, temperature variation, and component tolerances that would otherwise degrade measurement precision over time. The in-field recalibration capability avoids the need for external references or calibration cycles that interrupt normal operation, enabling the isolated energy meter system with auto-calibration 800 to maintain high measurement accuracy throughout the operational lifetime of the device without requiring removal from service or manual calibration procedures.

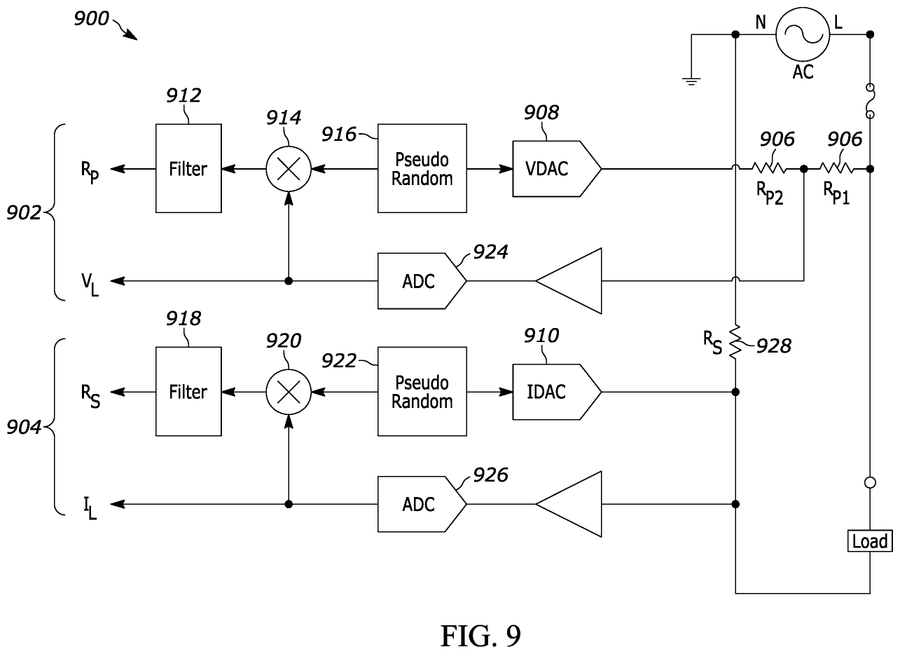

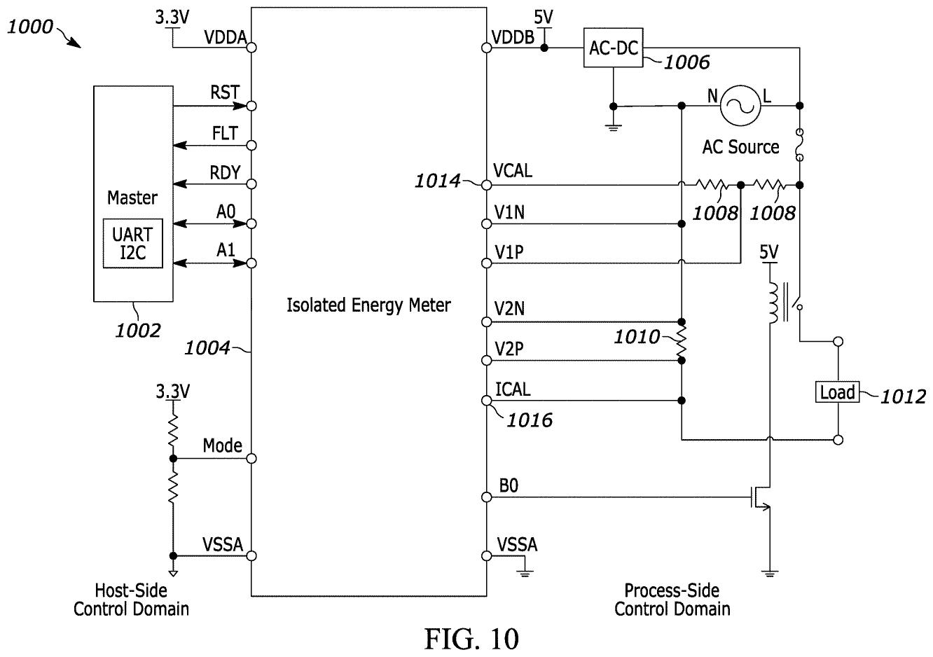

Referring to FIG. 9, a system diagram 900 illustrates an auto-calibration mechanism for the isolated energy meter, showing signal flow for both a voltage sensing path 902 and a current sensing path 904 with integrated pseudo-random calibration signal injection. The system diagram 900 depicts how calibration signals are injected into the sensing paths and how the energy measurement digital signal processor processes composite signals to extract calibration information and compute correction factors.

The upper portion of the system diagram 900 depicts the voltage sensing path 902. A resistor divider network formed by resistors 906 connects to an AC power line, with a line terminal and a neutral terminal connected to an AC source. A voltage digital-to-analog converter 908 injects a high-frequency voltage calibration signal in parallel with the AC voltage sensed across the resistor divider network. The voltage calibration signal is superimposed onto the sensed line voltage at a node between the resistor divider network and subsequent signal conditioning circuitry. An analog-to-digital converter 924 receives the composite signal from this node and outputs a voltage measurement signal that includes both the actual voltage waveform and the injected calibration signal.

With continued reference to FIG. 9, the lower portion of the system diagram 900 depicts the current sensing path 904. A shunt resistor 928 is connected in series with a load, developing a voltage proportional to the current flowing through the load. A current digital-to-analog converter 910 injects a high-frequency calibration signal into the current sensing path 904 via the shunt resistor 928 connection. The current calibration signal is superimposed onto the sensed current signal. An analog-to-digital converter 926 receives the composite signal and outputs a current measurement signal that includes both the actual current waveform and the injected calibration signal.

The first calibration signal and the second calibration signal traverse a same sensing path as actual measurements. The voltage calibration signal passes through the same resistor divider network formed by resistors 906, programmable gain amplifier, and analog-to-digital converter 924 as the actual voltage measurement signal. The current calibration signal passes through the same shunt resistor 928 interface, programmable gain amplifier, and analog-to-digital converter 926 as the actual current measurement signal. A full signal chain is exercised during calibration because the injected calibration signals traverse the complete analog front-end path from the sensing elements through the digitization stage. This arrangement ensures that any gain errors, offset errors, or nonlinearities introduced by components in the sensing paths affect both the actual measurement signals and the calibration signals in the same manner.

As further shown in FIG. 9, the isolated energy meter system further includes a filter and mixer block configured to demodulate the first calibration signal and the second calibration signal and calculate correction factors. The filter and mixer block is positioned in the signal processing chain after the analog-to-digital converters 924, 926. The voltage sensing path 902 includes a filter block 912 that receives the digitized composite signal and connects to a mixer block 914. The mixer block 914 receives a pseudo-random signal from a pseudo-random generator block 916. The mixer block 914 demodulates the calibration signal by correlating the received composite signal with the known pseudo-random sequence that was used to generate the injected calibration signal. A similar configuration including a filter block 918, a mixer block 920, and a pseudo-random generator block 922 is provided for the current sensing path 904.

The filter and mixer block includes filters configured to suppress energy frequency content and isolate the pseudo-random calibration signals. The filter blocks 912, 918 are designed to attenuate signal components at the fundamental power frequency and harmonics thereof while passing the higher-frequency calibration signal components. The frequency separation between the calibration signals and the power frequency content enables the filter blocks 912, 918 to isolate the pseudo-random calibration signals from the measurement signals. The isolated calibration signals are then processed by the mixer blocks 914, 920 to extract amplitude and phase information that indicates the transfer characteristics of the sensing paths.

In an example, the energy measurement digital signal processor is configured to compute gain deviations and offset deviations introduced by the voltage sensing path 902 and the current sensing path 904. The energy measurement digital signal processor analyzes the demodulated calibration signals from the filter blocks 912, 918 and mixer blocks 914, 920 to determine how the sensing paths have modified the known calibration signals. Gain deviations represent multiplicative errors where the sensing path amplifies or attenuates signals by an amount different from the expected gain. Offset deviations represent additive errors where the sensing path introduces a constant offset to the signal. The energy measurement digital signal processor quantifies both types of deviations for the voltage sensing path 902 and the current sensing path 904.

The energy measurement digital signal processor is configured to compare received calibration signals with expected signatures to compute the gain deviations and the offset deviations. The expected signatures correspond to the known pseudo-random calibration signals that were generated by the voltage digital-to-analog converter 908 and the current digital-to-analog converter 910. The energy measurement digital signal processor stores or computes the expected signatures and compares the received calibration signals against these expected signatures. Differences in amplitude between the received calibration signals and the expected signatures indicate gain deviations. Differences in baseline level indicate offset deviations. The comparison operation yields quantitative error metrics that characterize the current state of the sensing paths.

Error metrics from the filter and mixer block are used to compensate measurement parameters dynamically. The energy measurement digital signal processor applies the computed gain deviations and offset deviations as correction factors to the actual measurement signals. The correction factors adjust the measured voltage and current values to compensate for errors introduced by the voltage sensing path 902 and the current sensing path 904. The dynamic compensation updates the correction factors as the error metrics change, enabling the isolated energy meter system to track and correct for variations in sensing path characteristics over time.

The energy measurement digital signal processor is configured to continuously correct sensor drift. The digital signal processor continuously extracts and applies calibration coefficients during normal operation. The continuous extraction involves ongoing injection of calibration signals by the voltage digital-to-analog converter 908 and the current digital-to-analog converter 910, demodulation by the filter blocks 912, 918 and mixer blocks 914, 920, comparison with expected signatures, and computation of updated error metrics. The continuous application involves updating the correction factors used to compensate the actual measurement signals based on the most recent error metrics. This continuous correction maintains measurement accuracy without requiring interruption of the energy measurement function.

The auto-calibration avoids external references or calibration cycles that interrupt normal operation. The calibration signals are generated internally by the voltage digital-to-analog converter 908 and the current digital-to-analog converter 910, eliminating the need for external reference sources. The calibration processing occurs concurrently with normal energy measurement operations, eliminating the need for dedicated calibration cycles that would interrupt power monitoring. The frequency separation between the calibration signals and the power frequency content enables simultaneous calibration and measurement without mutual interference.

The auto-calibration enables in-field recalibration. The continuous, embedded nature of the auto-calibration mechanism allows the isolated energy meter system to maintain calibration accuracy throughout deployment without requiring removal from service or access by calibration technicians. The in-field recalibration capability supports long-term deployment in applications where physical access to the isolated energy meter system may be limited or where interruption of power monitoring is unacceptable.

The auto-calibration is configured to correct for aging effects. Aging effects in analog components such as resistors, amplifiers, and analog-to-digital converters cause gradual changes in gain and offset characteristics over time. The continuous monitoring of calibration signals by the filter blocks 912, 918 and mixer blocks 914, 920 enables the energy measurement digital signal processor to detect and compensate for these gradual changes, maintaining measurement accuracy as components age.

The auto-calibration is configured to correct for at least one of temperature variation and component tolerances. Temperature variation causes changes in the characteristics of analog components within the voltage sensing path 902 and the current sensing path 904, resulting in temperature-dependent gain and offset errors. Component tolerances cause initial variations in gain and offset characteristics from nominal values. The auto-calibration mechanism detects and compensates for errors arising from both temperature variation and component tolerances by continuously monitoring the actual transfer characteristics of the voltage sensing path 902 and the current sensing path 904 through the injected calibration signals.

Referring to FIG. 10, an application schematic 1000 demonstrates the practical deployment of the auto-calibration scheme within a single-phase power measurement configuration. The application schematic 1000 depicts the interconnection between a master controller 1002, an isolated energy meter with auto-calibration functionality 1004, and AC power measurement circuitry including calibration signal injection paths for both voltage and current sensing.

On the left side (e.g., host-side control domain) of the application schematic 1000, a master controller block 1002 with UART and I2C communication interfaces connects to the isolated energy meter 1004. The master controller 1002 operates from a 3.3V supply and connects to the isolated energy meter 1004 through multiple signal lines including a reset line, a fault indication line, and a ready status line. Address lines enable the master controller 1002 to communicate with the isolated energy meter 1004 using UART or I2C protocols for configuration and diagnostics. A mode pin connects through a resistor network to the 3.3V supply, allowing configuration of the operating mode. An analog ground reference pin provides the ground reference for the master side of the circuit.

With continued reference to FIG. 10, the isolated energy meter block 1004 includes multiple interface pins on both the master-facing side and the process-facing side. On the right side (process-side control domain), the isolated energy meter 1004 operates from a 5V supply derived from an AC-DC converter 1006 that receives power from the AC source. The process-side ground pin provides the ground reference for the process side, which is galvanically isolated from the master-side ground.

The AC source includes neutral and line connections. The line connection passes through the circuit to a load 1012 depicted on the right side of the application schematic 1000. A voltage sensing network including a resistor divider network formed by resistors 1008 connects between the line and neutral terminals of the AC source. The resistor divider network scales the AC line voltage to levels suitable for the analog front-end inputs of the isolated energy meter 1004. The divided voltage signal is fed to differential voltage input pins of the isolated energy meter 1004 for voltage measurement.

As further shown in FIG. 10, a voltage digital-to-analog converter within the isolated energy meter 1004 injects a high-frequency voltage calibration signal in parallel with the AC voltage sensed across the resistor divider. A voltage calibration output pin 1014 connects to the voltage sensing path, enabling the voltage calibration signal to be superimposed onto the sensed line voltage. The voltage calibration signal traverses the same sensing path as the actual voltage measurement signal, passing through the resistor divider interface and into the differential voltage inputs of the isolated energy meter 1004. This arrangement ensures that the voltage calibration signal exercises the full voltage sensing signal chain during calibration operations.

For current sensing, a shunt resistor 1010 is placed in series with the load 1012 on the line conductor. The voltage developed across the shunt resistor 1010 is proportional to the current flowing to the load 1012. Differential current input pins of the isolated energy meter 1004 connect across the shunt resistor 1010 to receive the current sense signal. The current sense signal is conditioned by programmable gain amplifiers and digitized by analog-to-digital converters within the isolated energy meter 1004 for processing by the energy measurement and auto-calibration digital signal processor.

With continued reference to FIG. 10, a current digital-to-analog converter within the isolated energy meter 1004 injects a high-frequency calibration signal into the current path via the shunt resistor 1010 connection. A current calibration output pin 1016 connects to the current sensing path through a resistor network referenced to the 5V supply. The current calibration signal is superimposed onto the sensed current signal at the differential current inputs of the isolated energy meter 1004. The current calibration signal traverses the same sensing path as the actual current measurement signal, exercising the full current sensing signal chain including the programmable gain amplifiers and analog-to-digital converters.

A bypass capacitor connects to a filter pin for filtering purposes, providing noise suppression for the process-side circuitry. The circuit configuration allows the voltage digital-to-analog converter to inject the high-frequency voltage calibration signal in parallel with the AC voltage sensed across the resistor divider network formed by the resistors 1008, while the current digital-to-analog converter injects the high-frequency calibration signal into the current path via the shunt resistor 1010 connection. Both calibration injection paths are integrated into the analog sensing front-end such that the calibration signals are superimposed onto the sensed line voltage and current.

The application schematic 1000 demonstrates how the auto-calibration mechanism operates without interrupting normal energy measurement operation. The energy measurement and auto-calibration digital signal processor continuously extracts and applies calibration coefficients while performing real-time power and energy computations. The master controller 1002 remains connected to the isolated energy meter 1004 via UART or I2C for configuration of calibration parameters, retrieval of computed power and energy metrics, and monitoring of calibration status and measurement accuracy.

The circuit layout in FIG. 10 demonstrates the separation between the low-voltage master-side domain operating at 3.3V and the process-side measurement domain operating at 5V while interfacing with AC mains voltage. The isolated energy meter 1004 provides the galvanic barrier between these domains while enabling both precision energy measurement and continuous in-system calibration. The integration of calibration signal injection within the sensing front-end enables sustained measurement accuracy over the lifetime of the device without requiring external calibration references or calibration cycles that would interrupt power monitoring operations.

A method for continuous in-system calibration of an isolated energy meter enables sustained measurement accuracy without requiring external references or calibration cycles that interrupt normal operation. The method includes a sequence of steps that inject known calibration signals into sensing paths, digitize composite signals, isolate the calibration signals from measurement signals, compute error metrics, and dynamically adjust compensation to correct sensor drift.

The method includes injecting, by a voltage digital-to-analog converter, a first pseudo-random calibration signal into a voltage sensing path. The voltage digital-to-analog converter generates the first pseudo-random calibration signal based on a known pseudo-random sequence. The first pseudo-random calibration signal is applied to the voltage sensing path such that the first pseudo-random calibration signal is superimposed onto actual voltage measurement signals from a power line being monitored. The injection of the first pseudo-random calibration signal into the voltage sensing path enables the calibration signal to traverse the same signal conditioning and digitization circuitry as the actual voltage measurement signals.

The first pseudo-random calibration signal occupies a frequency band higher than a fundamental power frequency. The fundamental power frequency may be 50 Hz or 60 Hz depending on the geographic region of deployment. The frequency band of the first pseudo-random calibration signal is selected to be above the fundamental power frequency and above harmonics of the fundamental power frequency that are present in the power line voltage waveform. The frequency separation between the first pseudo-random calibration signal and the power frequency content ensures that the injected calibration signal does not interfere with or corrupt the actual energy measurement being performed.

The method includes injecting, by a current digital-to-analog converter, a second pseudo-random calibration signal into a current sensing path. The current digital-to-analog converter generates the second pseudo-random calibration signal based on a known pseudo-random sequence. The second pseudo-random calibration signal is applied to the current sensing path such that the second pseudo-random calibration signal is superimposed onto actual current measurement signals from the power line being monitored. The injection of the second pseudo-random calibration signal into the current sensing path enables the calibration signal to traverse the same signal conditioning and digitization circuitry as the actual current measurement signals.

The second pseudo-random calibration signal occupies the frequency band higher than the fundamental power frequency. The frequency band of the second pseudo-random calibration signal may be the same as or different from the frequency band of the first pseudo-random calibration signal, provided that both frequency bands are above the fundamental power frequency and harmonics thereof. The frequency separation ensures that the second pseudo-random calibration signal does not interfere with the actual current measurement or with the voltage measurement operations.

The method includes digitizing, by a plurality of analog-to-digital converters, composite signals including actual measurement signals and the first and second pseudo-random calibration signals. The plurality of analog-to-digital converters includes at least a first analog-to-digital converter in the voltage sensing path and a second analog-to-digital converter in the current sensing path. The first analog-to-digital converter digitizes a first composite signal that includes the actual voltage measurement signal superimposed with the first pseudo-random calibration signal. The second analog-to-digital converter digitizes a second composite signal that includes the actual current measurement signal superimposed with the second pseudo-random calibration signal. The digitization operation converts the analog composite signals into digital representations for subsequent processing by a digital signal processor.

The method includes isolating, by a digital signal processor, the first and second pseudo-random calibration signals from the actual measurement signals using digital filtering and spectral separation. The digital signal processor applies digital filtering to the digitized composite signals to attenuate signal components at the fundamental power frequency and harmonics thereof while passing the higher-frequency calibration signal components. The spectral separation exploits the frequency band separation between the calibration signals and the measurement signals to distinguish between the two signal components within each composite signal. The digital filtering and spectral separation operations yield isolated representations of the first pseudo-random calibration signal and the second pseudo-random calibration signal that have been modified by the respective sensing paths.

The method includes computing, by the digital signal processor, gain deviations and offset deviations by comparing received calibration signals with expected signatures. The expected signatures correspond to the known pseudo-random calibration signals that were generated by the voltage digital-to-analog converter and the current digital-to-analog converter. The digital signal processor compares the isolated calibration signals received through the sensing paths against the expected signatures to determine how the sensing paths have modified the calibration signals. Differences in amplitude between the received calibration signals and the expected signatures indicate gain deviations introduced by the sensing paths. Differences in baseline level indicate offset deviations introduced by the sensing paths. The digital signal processor computes quantitative values for the gain deviations and offset deviations for both the voltage sensing path and the current sensing path.

The method includes dynamically adjusting, by the digital signal processor, compensation algorithms to correct sensor drift based on the computed gain deviations and offset deviations. The digital signal processor applies the computed gain deviations and offset deviations as correction factors within compensation algorithms that process the actual measurement signals. The compensation algorithms adjust the measured voltage and current values to compensate for errors introduced by the sensing paths. The dynamic adjustment updates the correction factors as the computed gain deviations and offset deviations change over time, enabling the isolated energy meter to track and correct for variations in sensing path characteristics. The dynamic adjustment of compensation algorithms maintains measurement accuracy as components age, as temperature varies, and as other factors cause drift in the sensing path characteristics.

The method may be performed continuously during normal operation of the isolated energy meter. The continuous performance of the method enables the isolated energy meter to maintain calibration accuracy without requiring dedicated calibration cycles that would interrupt power monitoring operations. The injection of calibration signals, digitization of composite signals, isolation of calibration signals, computation of deviations, and dynamic adjustment of compensation algorithms may occur concurrently with the computation of power and energy metrics from the actual measurement signals.

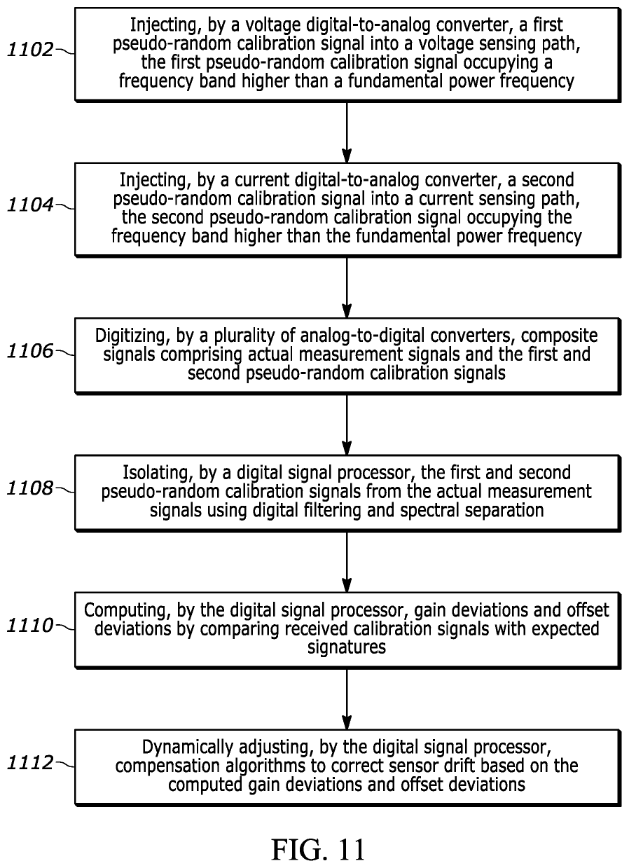

Referring to FIG. 11, a flowchart illustrates a method for calibration of an energy meter. The method begins at step 1102, where a voltage digital-to-analog converter injects a first pseudo-random calibration signal into a voltage sensing path. The first pseudo-random calibration signal occupies a frequency band higher than a fundamental power frequency. The voltage digital-to-analog converter generates the first pseudo-random calibration signal based on a known pseudo-random sequence and applies the first pseudo-random calibration signal to the voltage sensing path such that the first pseudo-random calibration signal is superimposed onto actual voltage measurement signals from a power line being monitored.

At step 1104, a current digital-to-analog converter injects a second pseudo-random calibration signal into a current sensing path. The second pseudo-random calibration signal occupies the frequency band higher than the fundamental power frequency. The current digital-to-analog converter generates the second pseudo-random calibration signal based on a known pseudo-random sequence and applies the second pseudo-random calibration signal to the current sensing path such that the second pseudo-random calibration signal is superimposed onto actual current measurement signals from the power line being monitored.

At step 1106, a plurality of analog-to-digital converters digitize composite signals including actual measurement signals and the first and second pseudo-random calibration signals. The plurality of analog-to-digital converters includes at least a first analog-to-digital converter in the voltage sensing path and a second analog-to-digital converter in the current sensing path. The digitization operation converts the analog composite signals into digital representations for subsequent processing.

At step 1108, a digital signal processor isolates the first and second pseudo-random calibration signals from the actual measurement signals using digital filtering and spectral separation. The digital signal processor applies digital filtering to the digitized composite signals to attenuate signal components at the fundamental power frequency and harmonics thereof while passing the higher-frequency calibration signal components. The spectral separation exploits the frequency band separation between the calibration signals and the measurement signals to distinguish between the two signal components.

At step 1110, the digital signal processor computes gain deviations and offset deviations by comparing received calibration signals with expected signatures. The expected signatures correspond to the known pseudo-random calibration signals that were generated by the voltage digital-to-analog converter and the current digital-to-analog converter. Differences in amplitude between the received calibration signals and the expected signatures indicate gain deviations, and differences in baseline level indicate offset deviations.

At step 1112, the digital signal processor dynamically adjusts compensation algorithms to correct sensor drift based on the computed gain deviations and offset deviations. The compensation algorithms adjust the measured voltage and current values to compensate for errors introduced by the sensing paths. The dynamic adjustment updates the correction factors as the computed gain deviations and offset deviations change over time, maintaining measurement accuracy without interrupting normal energy measurement operation.

The entire systems as described, for example, with reference to FIGS. 1 and 2 may be integrated onto a single module. In some aspects, the master module may be implemented as one semiconductor device, such as an integrated circuit device or chip. The slave module may be implemented as a separate semiconductor device, such as another integrated circuit device or chip. The galvanically isolated barrier may be implemented as another separate device disposed between the master module and the slave module. This configuration may be similar to, or the same as, the configuration described in U.S. Pat. No. 11,706,057.

Although the architectures and methods described herein are illustrated with reference to specific application domains such as data centers, electric vehicle charging infrastructure, battery management systems, industrial automation networks, and three-phase power analysis, the disclosed systems and methods are not limited to these applications. The architectures and methods may be applied to any system requiring galvanic isolation between domains, precision measurement, synchronized operation across isolated subsystems, or continuous in-system calibration. Other applications may include, without limitation, medical device systems, telecommunications equipment, aerospace and avionics systems, renewable energy systems, smart grid infrastructure, consumer electronics, and any other application where galvanic isolation, fault handling, or measurement accuracy is desired.

A number of implementations have been described. Nevertheless, it will be understood that various modifications may be made without departing from the spirit and scope of the disclosure. Accordingly, other implementations are within the scope of the following claims.

1. An interface system comprising:
an edge domain comprising an edge processing unit configured to execute diagnostic and networking functions, a first fault handling subsystem configured to detect and respond to abnormal conditions, and a first isolated transceiver;
a process domain comprising a process interface configured to connect to at least one of sensors, actuators, and power electronics, a second fault handling subsystem configured to detect and respond to abnormal conditions, and a second isolated transceiver;
a galvanically isolated barrier disposed between the edge domain and the process domain, the galvanically isolated barrier providing galvanic isolation between the edge domain and the process domain; and
wherein the first isolated transceiver and the second isolated transceiver are configured to communicate via packet-based serial communication across the galvanically isolated barrier, and wherein the edge domain and the process domain are independently powered.

2. The interface system of claim 1, wherein the first isolated transceiver comprises a first serializer-deserializer configured to serialize outgoing data packets and deserialize incoming data packets, and the second isolated transceiver comprises a second serializer-deserializer configured to serialize outgoing data packets and deserialize incoming data packets, and wherein the first isolated transceiver and the second isolated transceiver are configured to communicate via full-duplex communication.

3. The interface system of claim 2, wherein the first isolated transceiver and the second isolated transceiver are configured to use Manchester encoding and at least one of On-Off Keying modulation and Amplitude Shift Keying modulation.

4. The interface system of claim 1, wherein the galvanically isolated barrier comprises embedded ground shields configured to suppress electromagnetic interference.

5. The interface system of claim 1, wherein the galvanically isolated barrier comprises capacitive coupling structures formed in a multilayer printed circuit board.

6. The interface system of claim 1, wherein the galvanically isolated barrier comprises inductive coupling structures.

7. The interface system of claim 1, wherein the edge processing unit is configured to run a real-time operating system and implement at least one of diagnostic functions, analytics functions, and networking functions.

8. The interface system of claim 7, wherein the edge processing unit is configured to support at least one of Ethernet protocols and IP protocols.

9. The interface system of claim 1, wherein the first fault handling subsystem is configured to detect at least one of abnormal electrical conditions and abnormal thermal conditions.

10. The interface system of claim 9, wherein the first fault handling subsystem is configured to initiate containment actions without relying on a system processor.

11. The interface system of claim 1, further comprising a synchronization mechanism configured to coordinate operation across the edge domain and the process domain by encoding a trigger signal within a serial communication protocol.

12. The interface system of claim 11, wherein the first isolated transceiver is configured to operate as a master and generate the trigger signal, and wherein the first isolated transceiver is configured to encode the trigger signal in at least one of a packet preamble and a packet header.

13. The interface system of claim 12, wherein the second isolated transceiver is configured to operate as a slave and detect the trigger signal from an incoming data packet and assert a local trigger input signal to initiate a time-aligned operation.

14. The interface system of claim 11, wherein the synchronization mechanism is scalable to coordinate operation across a plurality of slave subsystems, each slave subsystem independently decoding the trigger signal from a packet preamble.

15. The interface system of claim 11, wherein the synchronization mechanism provides deterministic latency between generation of the trigger signal and detection of the trigger signal, the deterministic latency governed by serialization delay and transmission delay of the serial communication protocol.

16. The interface system of claim 11, wherein the first isolated transceiver and the second isolated transceiver are configured to support full-duplex communication while honoring synchronized triggers.

17. An interface system comprising:
an edge domain comprising an edge processing unit, a first fault handling subsystem, and a master transceiver module, the master transceiver module comprising a media access controller, a packet generator configured to assemble request packets with command codes and data, and a transmit path comprising a header addition block, a serializer configured to perform serialization, and a checksum addition block;
a process domain comprising a process interface, a second fault handling subsystem, and a slave transceiver module, the slave transceiver module comprising a receive path comprising a header detection block, a deserializer configured to perform deserialization, and a checksum comparison block;
a galvanically isolated barrier disposed between the edge domain and the process domain; and
wherein the master transceiver module and the slave transceiver module are configured to communicate via full-duplex, packet-based serial communication across the galvanically isolated barrier.

18. The interface system of claim 17, wherein the master transceiver module further comprises a receive path comprising a header detection block, a deserializer, and a checksum comparison block, and wherein the slave transceiver module further comprises a transmit path comprising a header addition block, a serializer, and a checksum addition block.

19. The interface system of claim 17, wherein the master transceiver module is configured to handle link integrity monitoring, interrupt generation, and slave-side status indicators.

20. An interface system comprising:
a master subsystem comprising a master transceiver with an internal trigger logic block configured to generate a trigger pulse and a transmit block configured to encode the trigger pulse into a preamble or header of an outgoing data packet;
a plurality of slave subsystems, each slave subsystem comprising a slave transceiver with a receive block configured to detect the trigger pulse from an incoming data packet and assert a local trigger input signal; and
a galvanically isolated barrier disposed between the master subsystem and each of the plurality of slave subsystems;
wherein the master subsystem and the plurality of slave subsystems are configured to achieve deterministic synchronization across the galvanically isolated barrier without a shared physical clock.
